(19) United States
(12) Patent Application Publication
(10) Pub. No.: US 2019/0294263 A1
(43) Pub. Date: Sep. 26, 2019

(54) INFORMATION PROCESSING DEVICE, INFORMATION PROCESSING METHOD, AND PROGRAM

(71) Applicant: SONY CORPORATION, TOKYO (JP)

(72) Inventors: YOUSUKE KAWANA, TOKYO (JP); TAKUYA IKEDA, TOKYO (JP); RYUICHI SUZUKI, TOKYO (JP); MAKI IMOTO, TOKYO (JP); KENTARO IDA, TOKYO (JP)

(21) Appl. No.: 16/301,147

(22) PCT Filed: Apr. 10, 2017
(86) PCT No.: PCT/JP2017/014690

§ 371 Date: Nov. 13, 2018

(30) Foreign Application Priority Data
May 30, 2016 (JP) 2016-107112

(51) Int. Cl. G06F 3/038; G06F 3/0346; G06F 3/01

(52) U.S. Cl. CPC G06F 3/038; G06F 3/017; G06F 3/0346

(57) ABSTRACT

[Object] To provide a structure capable of reducing stress which a user feels in a manipulation of a device.

[Solution] An information processing device including: a decision unit configured to decide a first reference direction of a manipulation by a manipulator on a basis of information regarding an aspect of a part of a body of a user; and a control unit configured to control an output related to the manipulation in accordance with information regarding a motion of the manipulator with respect to the decided first reference direction. An information processing method including, by a processor: deciding a first reference direction of a manipulation by a manipulator on a basis of information regarding an aspect of a part of a body of a user; and controlling an output related to the manipulation in accordance with information regarding a motion of the manipulator with respect to the decided first reference direction. A program causing the information processing device to operate.

### TECHNICAL FIELD

The present disclosure relates to an information processing device, an information processing method, and a program.

### BACKGROUND ART

In recent years, with development of information processing technologies, various technologies related to an input for manipulating devices have been researched and developed. Specifically, there are technologies related to inputs in 2-dimensional spaces using a mouse, a touch panel, or the like and there are technologies related to inputs in 3-dimensional spaces based on recognized gestures or the like of users.

Here, in technologies of the related art, coordinate systems for input manipulations were generally fixed. For example, in manipulations performed using touch panels, coordinate systems of touch inputs were fixed by being mapped to coordinate systems of display regions. In addition, in gesture manipulations, for example, coordinate systems of inputs recognized by pointing were fixed by being mapped to coordinate systems of virtual spaces. In this way, in the technologies of the related art, users had to perform manipulations in accordance with coordinate systems set by devices.

In contrast, Patent Literature 1 discloses an invention relating to an information input device that controls a display position of a user interface element by causing central coordinates of a user interface element for performing an input manipulation to follow a motion of a user. In Patent Literature 1, even when a user has moved, a user interface element is considered to be able to be manipulated with substantially the same motion as a motion before the movement.

### CITATION LIST

### Patent Literature

Patent Literature 1: JP 2015-90547A

### DISCLOSURE OF INVENTION

### Technical Problem

However, manipulation interfaces which are easier for users to handle have been required. For example, in the invention disclosed in Patent Literature 1, a direction of a manipulation of the user interface element is not mentioned. In the technologies of the related art, since coordinate systems were fixed, as described above, directions serving as references for deciding directions of manipulations (hereinafter also referred to as reference directions) were also fixed. Therefore, users had to perform manipulations in fixed directions set by devices.

Accordingly, the present disclosure proposes a structure capable of reducing stress which a user feels in a manipulation of a device.

### Solution to Problem

According to the present disclosure, there is provided an information processing device including: a decision unit configured to decide a first reference direction of a manipulation by a manipulator on a basis of information regarding an aspect of a part of a body of a user; and a control unit configured to control an output related to the manipulation in accordance with information regarding a motion of the manipulator with respect to the decided first reference direction.

In addition, according to the present disclosure, there is provided an information processing method including, by a processor: deciding a first reference direction of a manipulation by a manipulator on a basis of information regarding an aspect of a part of a body of a user; and controlling an output related to the manipulation in accordance with information regarding a motion of the manipulator with respect to the decided first reference direction.

In addition, according to the present disclosure, there is provided a program causing a computer to realize: a decision function of deciding a first reference direction of a manipulation by a manipulator on a basis of information regarding an aspect of a part of a body of a user; and a control function of controlling an output related to the manipulation in accordance with information regarding a motion of the manipulator with respect to the decided first reference direction.

### Advantageous Effects of Invention

According to the present disclosure, as described above, it is possible to provide a structure capable of reducing stress which a user feels in a manipulation of a device. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a configuration example of an information processing system according to an embodiment of the present disclosure.

FIG. 2 is a block diagram conceptually illustrating an example of a functional configuration of an information processing device according to the embodiment of the present disclosure.

FIG. 3 is an explanatory diagram illustrating an example of a method of deciding a first reference direction in the information processing device according to the embodiment of the present disclosure.

FIG. 4 is an explanatory diagram illustrating another example of the method of deciding the first reference direction in the information processing device according to the embodiment of the present disclosure.

FIG. 5 is an explanatory diagram illustrating still another example of the method of deciding the first reference direction in the information processing device according to the embodiment of the present disclosure.

FIG. 6 is a flowchart conceptually illustrating an example of a whole process of the information processing device according to the embodiment of the present disclosure.

FIG. 7 is a flowchart conceptually illustrating an example of a feedback control process in the first reference direction in the information processing device according to the embodiment of the present disclosure.

FIG. 8 is a flowchart conceptually illustrating an example of a fixing control process in the first reference direction in the information processing device according to the embodiment of the present disclosure.

FIG. 9A is an explanatory diagram illustrating a first operation example of the information processing device according to the embodiment of the present disclosure.

FIG. 9B is an explanatory diagram illustrating a second operation example of the information processing device according to the embodiment of the present disclosure.

FIG. 9C is an explanatory diagram illustrating a third operation example of the information processing device according to the embodiment of the present disclosure.

FIG. 10 is an explanatory diagram illustrating an example of a method of deciding a first reference direction in an information processing device according to a first modification example of the embodiment of the present disclosure.

FIG. 11 is an explanatory diagram illustrating an example of a method of deciding a first reference direction in an information processing device according to a second modification example of the embodiment of the present disclosure.

FIG. 12 is an explanatory diagram illustrating another example of the method of deciding the first reference direction in the information processing device according to a second modification example of the embodiment of the present disclosure.

FIG. 13 is a flowchart conceptually illustrating an example of the fixing control process in the first reference direction in the information processing device according to a third modification example of the embodiment of the present disclosure.

FIG. 14 is a flowchart conceptually illustrating another example of the fixing control process in the first reference direction in the information processing device according to the third modification example of the embodiment of the present disclosure.

FIG. 15 is an explanatory diagram illustrating an example of a method of deciding the first reference direction in the information processing device according to a fourth modification example of the embodiment of the present disclosure.

FIG. 16 is an explanatory diagram illustrating another example of a method of deciding the first reference direction in the information processing device according to the fourth modification example of the embodiment of the present disclosure.

FIG. 17 is a diagram illustrating a display example of a reference object in the information processing device according to a fifth modification example of the embodiment of the present disclosure.

FIG. 18 is an explanatory diagram illustrating an example in which the first reference direction is managed with regard to each of a plurality of users in the information processing device in a sixth modification example of the embodiment of the present disclosure.

FIG. 19 is an explanatory diagram illustrating an example of demonstration of a manipulation in the information processing device according to a seventh modification example of the embodiment of the present disclosure.

FIG. 20 is an explanatory diagram illustrating a hardware configuration of an information processing device according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. Embodiment of present disclosure
1.1. System configuration
1.2. Configuration of device
1.3. Process of device
1.4. Operation example
1.5. Summary of embodiment of present disclosure
1.6. Modification examples
2. Hardware configuration of information processing device according to embodiment of present disclosure

### 3. Conclusion

### 1. EMBODIMENT OF PRESENT DISCLOSURE

An information processing system according to an embodiment of the present disclosure and an information processing device realizing the information processing system will be described.

### 1.1. System Configuration

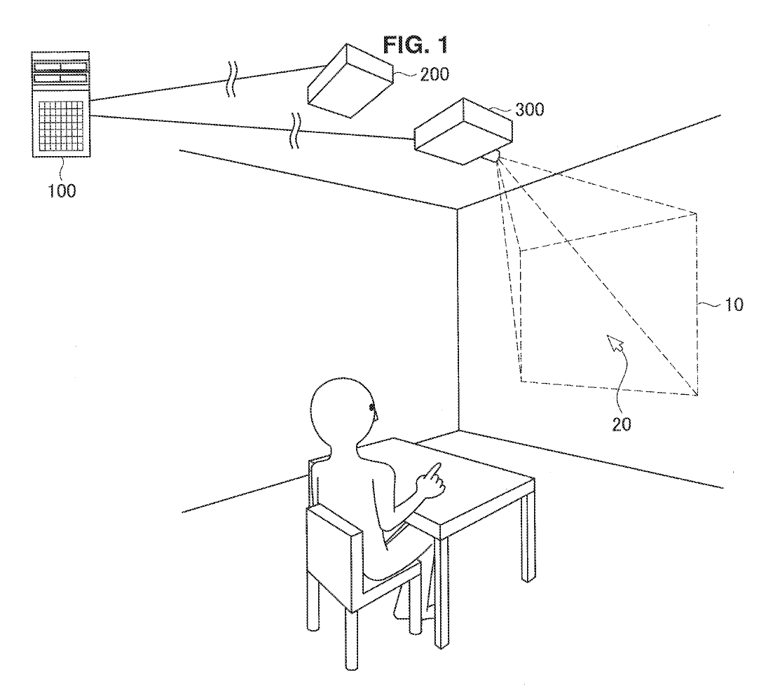

First, a configuration of the information processing system according to the embodiment of the present disclosure will be described with reference to FIG. 1. FIG. 1 is a diagram illustrating a configuration example of the information processing system according to the embodiment of the present disclosure.

As illustrated in FIG. 1, the information processing system includes an information processing device 100, a measurement device 200, and a projection device 300. The information processing device 100, and the measurement device 200 and the projection device 300 are connected and can communicate with each other.

The information processing device 100 controls projection of the projection device 300 using a measurement result of the measurement device 200. Specifically, the information processing device 100 recognizes a part of the body of a user from the measurement result supplied from the measurement device 200. Then, the information processing device 100 controls an aspect of the projection by the projection device 300 on the basis of the recognized part of the body. For example, the information processing device 100 controls a projection position or the like of a virtual object 20 which the projection device 300 is caused to project on the basis of a position relation of a hand of the user measured by the measurement device 200. The details will be described below.

The measurement device 200 measures a surrounding situation of the measurement device 200. Specifically, the measurement device 200 measures a phenomenon in which a position relation or a state of an object near the measurement device 200, for example, a user or the like, is grasped. Then, the measurement device 200 supplies information obtained through the measurement (hereinafter also referred to as measurement information) to the information processing device 100 as a measurement result. For example, the measurement device 200 is a depth sensor and can measure a positional relation between a part of the body (for example, a hand) on which a marker is mounted and a nearby object (that is, positions of the part of the body and the nearby object in a 3-dimensional space) by mounting the marker on the part of the body of the user. The measurement information may be 3-dimensional image information. Note that the measurement device 200 may be an inertial sensor mounted on the user.

The projection device 300 projects an image on the basis of instruction of the information processing device 100. Specifically, the projection device 300 projects the image supplied from the information processing device 100 to an instructed place. For example, the projection device 300 projects the virtual object 20 to the projection region 10 illustrated in FIG. 1 as instructed by the information processing device 100.

Here, in the related art, an instrument is used in a manipulation of a device. For example, a mouse, a remote controller, or the like is used as the instrument. However, in a manipulation performed using an instrument, a user feels stress in some cases. For example, in a case in which an instrument for a device on which a manipulation is desired is not found, a user has to find out the instrument. In addition, since a reference direction of a manipulation set by the above-described device is generally fixed with respect to an attitude of the instrument, the user has to arrange the attitude of the instrument so that the user can perform a desired manipulation.

In addition, a device is manipulated in accordance with a motion of a user such as a gesture without using an instrument in some cases. However, even in this case, since the reference direction of the manipulation is also fixed by setting of the device, there is concern of a burden on the user, such as a forced unreasonable attitude.

Accordingly, the present disclosure proposes an information processing system capable of reducing stress which a user feels in a manipulation of a device and the information processing device 100 realizing this information processing system.

### 1.2. Configuration of Device

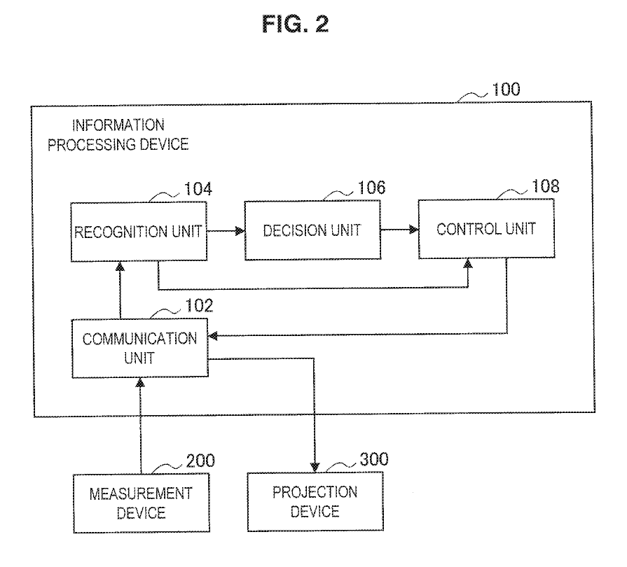

Next, a configuration of the information processing device 100 according to an embodiment of the present disclosure will be described with reference to FIG. 2. FIG. 2 is a block diagram conceptually illustrating an example of a functional configuration of the information processing device 100 according to the embodiment of the present disclosure.

As illustrated in FIG. 2, the information processing device 100 includes a communication unit 102, a recognition unit 104, a decision unit 106, and a control unit 108.

### (Communication Unit)

The communication unit 102 communicates with an external device of the information processing device 100. Specifically, the communication unit 102 receives a measurement result from the measurement device 200 and transmits projection instruction information to the projection device 300. For example, the communication unit 102 communicates with the measurement device 200 and the projection device 300 in conformity with a wired communication scheme. Note that the communication unit 102 may communicate in conformity with a wireless communication scheme.

### (Recognition Unit)

The recognition unit 104 performs a recognition process on the basis of the measurement result of the measurement device 200. Specifically, the recognition unit 104 recognizes an aspect of a part of the body of the user on the basis of the measurement information received from the measurement device 200. As the aspect of the part of the body, there is a shape of the part of the body. For example, the recognition unit 104 recognizes a shape of a hand of the user on the basis of 3-dimensional image information obtained from the measurement device 200. The shape of the hand changes in accordance with the number of folded fingers, a way of folding the fingers, or the like. Note that the part of the body recognized by the recognition unit 104 may be a manipulator.

In addition, the aspect of the part of the body may be a positional relation between a first part and a second part adjacent to the first part. For example, the recognition unit 104 recognizes a positional relation between fingers of a hand recognized on the basis of 3-dimensional image information obtained from the measurement device 200 and the back of the hand. Note that the positional relation between specific fingers and the back of the hand may be recognized.

In addition, the recognition unit 104 recognizes an action of the user. Specifically, the recognition unit 104 recognizes an action involving a motion of the user on the basis of the 3-dimensional image information obtained from the measurement device 200. As the action involving the motion of the user, there is a change in an attitude, a gesture, acquisition of a specific object, a movement to a specific location, or start of a manipulation by a manipulator. The details of the action involving the motion will be described below.

### (Decision Unit)

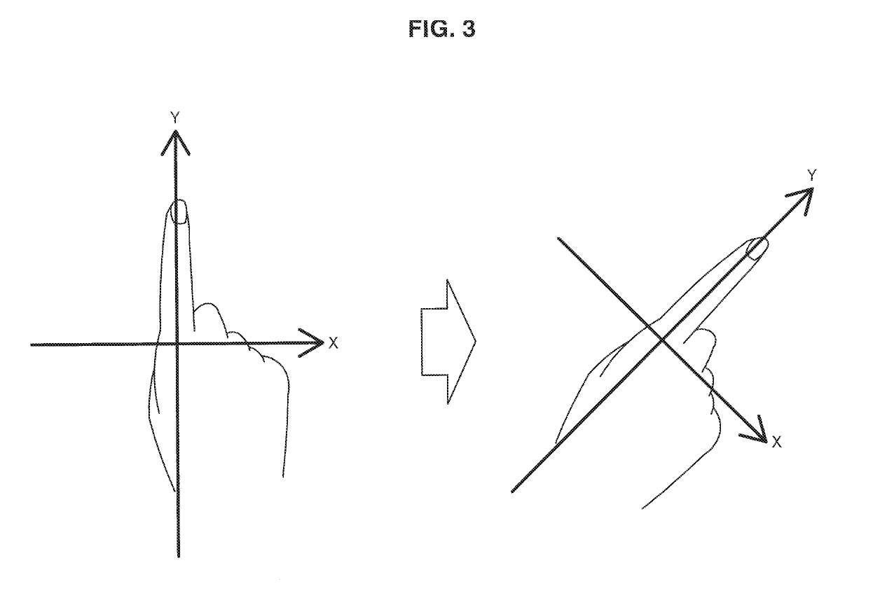

The decision unit 106 decides the first reference direction of a manipulation by a manipulator on the basis of an aspect of a part of the body of the user recognized by the recognition unit 104. Specifically, the decision unit 106 decides the first reference direction on the basis of a shape of a part of the body recognized by the recognition unit 104. Further, the decision of the first reference direction will be described in detail with reference to FIG. 3. FIG. 3 is an explanatory diagram illustrating an example of a method of deciding the first reference direction in the information processing device 100 according to the embodiment of the present disclosure.

First, a shape of a specific part of the body is recognized by the recognition unit 104. For example, a hand of a stretched index finger, as illustrated in FIG. 3, is recognized by the recognition unit 104. In other words, a shape of the hand of which a part protrudes in one direction is recognized.

When the shape of the specific part of the body is recognized, the decision unit 106 decides the first reference direction in accordance with the recognized shape of the specific part of the body. For example, the decision unit 106 decides a direction in which the index finger of the hand, as illustrated in FIG. 3, is stretched as the Y axis direction. In addition, the decision unit 106 decides a direction orthogonal to the Y axis as the X axis direction. In other words, the decision unit 106 decides the one direction as the Y axis direction from the shape of the hand of which the part protrudes in one direction. Note that FIG. 3 illustrates the example in which the X axis and the Y axis are decided so that a starting point of a movement of the base of the index finger, that is, the specific part of the body is the origin, but the position of the origin is not limited thereto. For example, the X axis may be decided so that a fingertip is the origin.

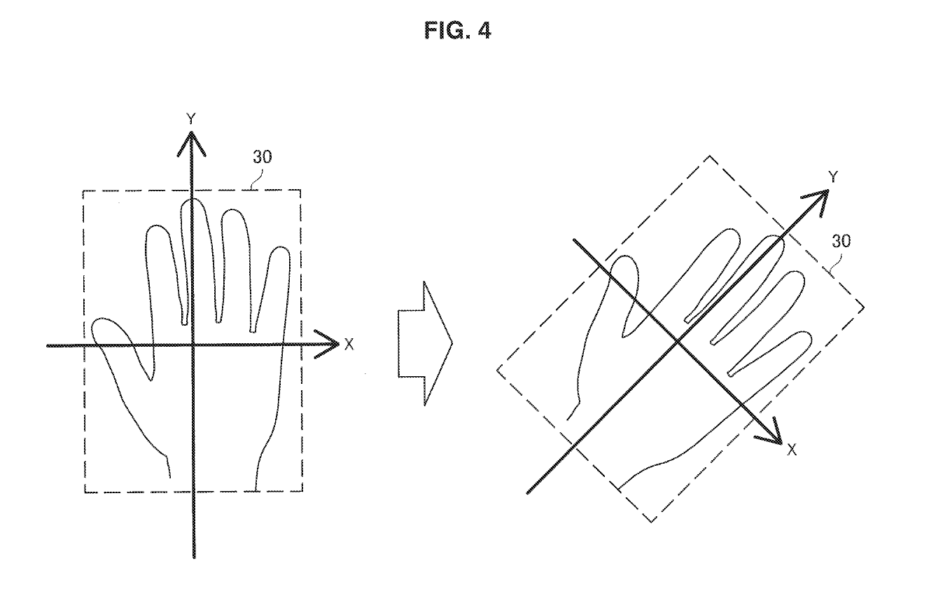

In addition, the decision unit 106 may decide the first reference direction on the basis of a shape of a region decided from the shape of the specific part of the body. The decision of the first reference direction based on the shape of the region will be described with reference to FIG. 4. FIG. 4 is an explanatory diagram illustrating another example of the method of deciding the first reference direction in the information processing device 100 according to the embodiment of the present disclosure.

First, the shape of the specific part of the body is recognized by the recognition unit 104. For example, a hand of which all the fingers are stretched, as illustrated in FIG. 4, is recognized by the recognition unit 104. In other words, a shape of the hand of which main parts protrude mainly in two directions (a stretching direction of a thumb and a stretching direction of the other fingers) is recognized.

When the shape of the specific part of the body is recognized, the decision unit 106 decides a region from the recognized shape of the specific part of the body. For example, the decision unit 106 decides a region 30 including the whole recognized shape of the hand, as illustrated in FIG. 4. Note that the shape of the region 30 is a rectangle in FIG. 4, but the shape of the region 30 is not limited thereto. For example, the shape of the region 30 may be a triangle, may be a polygon with five or more vertexes, or may be a curved shape.

Subsequently, the decision unit 106 decides the first reference direction on the basis of the shape of the decided region. For example, the decision unit 106 decides a long-side direction of the decided rectangular shape of the region 30 as the Y axis direction and a short-side direction of the decided rectangular shape as the X axis direction. Note that FIG. 4 illustrates an example in which an orthogonal point of the X axis and the Y axis is a center of the region 30, but the orthogonal point may be any point which is inside the region 30 and is orthogonal to the Y axis.

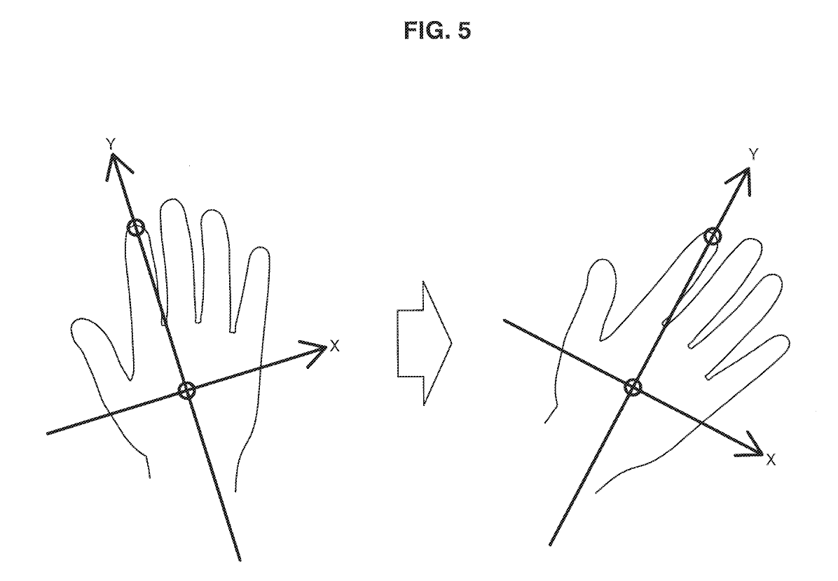

In addition, the decision unit 106 may decide the first reference direction on the basis of a positional relation between the first part and the second part related to a movable range of the first part. The decision of the first reference direction based on the positional relation will be described in detail with reference to FIG. 5. FIG. 5 is an explanatory diagram illustrating still another example of the method of deciding the first reference direction in the information processing device 100 according to the embodiment of the present disclosure.

First, the first part and the second part of the body are recognized by the recognition unit 104. For example, the index finger and the back of the hand, as illustrated in FIG. 5, are recognized by the recognition unit 104. In addition, a position of the index finger and a position of the back of the hand are recognized.

When the first part and the second part of the body are recognized, the decision unit 106 decides the first reference direction on the basis of the positional relation between the recognized first part and second part. For example, the decision unit 106 decides a straight line connecting the position of the index finger to the position of the back of the hand, as illustrated in FIG. 5, as the Y axis direction serving as the first reference direction. In addition, the decision unit 106 decides a direction in which the Y axis is orthogonal to the back of the hand as the X axis direction serving as the first reference direction. Note that a direction oriented from the back of the hand to the index finger is decided as a positive direction of the Y axis.

The decision of the first reference direction by the decision unit 106 has been described above. Further, the decision unit 106 controls fixing of the decided first reference direction on the basis of a predetermined trigger. Specifically, the first reference direction is fixed on the basis of information regarding to an action of the user with respect to a target of a manipulation by the manipulator. More specifically, the decision unit 106 fixes the first reference direction in accordance with an attitude of the specific part of the body at the current time point on the basis of an action involving a motion of the user recognized by the recognition unit 104. For example, the decision unit 106 fixes the decided first reference direction when the recognition unit 104 recognizes that the body of the user faces the projection region 10 to which a virtual object which is a manipulation target is projected, as a change in the attitude. An unfixed first reference direction is changed in accordance with a motion of the hand so that the unfixed first reference direction follows the motion of the hand, as illustrated in FIGS. 3 to 5. On the other hand the fixed first reference direction is not changed regardless of the motion of the hand.

In addition, as an action of the user, there is a gesture. For example, the decision unit 106 fixes the decided first reference direction when the recognition unit 104 recognizes a specific gesture. In addition, as an action of the user, there is acquisition of a specific object. For example, the decision unit 106 fixes the decided first reference direction when the recognition unit 104 recognizes that the user takes a specific instrument (for example, a manipulator) in his or her hand. In addition, as an action of the user, there is a movement to a specific location. For example, the decision unit 106 fixes the decided first reference direction when the recognition unit 104 recognizes that the user sits at a specific location (for example, a sofa). In addition, as an action of the user, there is start of a manipulation by a manipulator. For example, the decision unit 106 fixes the decided first reference direction when the recognition unit 104 recognizes a manipulation (for example, a touch on a predetermined location) by the manipulator.

Further, the decision unit 106 releases the fixing of the first reference direction. Specifically, the decision unit 106 releases the fixing of the first reference direction on the basis of an action involving a motion of the user. More specifically, the decision unit 106 releases the fixing of the first reference direction when the recognition unit 104 recognizes that a manipulation by the manipulator has ended. For example, the fixing of the first reference direction is released when it is detected that a finger or a hand touching a predetermined location becomes away from a predetermined location.

Note that the decision unit 106 may release the fixing of the first reference direction when a motion related to the fixing of the first reference direction recognized by the recognition unit 104 is stopped or paused for a predetermined time. For example, the fixing of the first reference direction is released when it is detected that a motion of a finger or a hand touching a predetermined location is at a standstill for a predetermined time.

In addition, the decision unit 106 may release the fixing of the first reference direction when the recognition unit 104 recognizes a specific motion different from a motion related to the fixing of the first reference direction. For example, the fixing of the first reference direction is released when it is detected that a motion such as shaking which the user performs bit by bit with his or her finger or hand touching a predetermined location.

### (Control Unit)

The control unit 108 generally controls a process of the information processing device 100. Specifically, the control unit 108 controls an output related to a manipulation in accordance with a motion of a manipulator with respect to the decided first reference direction. Particularly, the control unit 108 controls projection of the projection device 300 on the basis of a motion of a manipulator recognized by the recognition unit 104 and the first reference direction. For example, the control unit 108 decides a manipulation direction and a manipulation amount with reference to the fixed first reference direction on the basis of a movement direction and a movement distance of a manipulator recognized by the recognition unit 104. Then, the control unit 108 controls a projection position of a virtual object in accordance with the decided manipulation direction and manipulation amount, controls projection or non-projection of a virtual object, or switches a virtual object to be projected.

In addition, the control unit 108 controls an output of notification with respect to the decided first reference direction. Specifically, the control unit 108 causes the projection device 300 to project a virtual object indicating the decided first reference direction (hereinafter also referred to as a reference object). For example, the control unit 108 causes the projection device 300 to project reference objects indicating the Y axis direction and the X axis direction serving as the first reference direction inside the projection region 10 illustrated in FIG. 1.

Further, the control unit 108 controls an aspect of the foregoing notification. Specifically, the control unit 108 controls the aspect of the foregoing notification on the basis of an aspect of a part of a body used to decide the first reference direction. Particularly, the control unit 108 decides an aspect of notification in accordance with the number of aspects of the part of the boy used to decide the first reference direction. For example, the control unit 108 decides the aspects of the reference object which are easier to view (for example, hue, saturation, luminance, transparency, a size, or a shape), as described above, as the number of aspects of the part of the body used to decide the first reference direction is larger.

Note that the control unit 108 may decide an aspect of notification in accordance with kinds of aspects of the part of the body used to decide the first reference direction. For example, in a case in which information regarding a shape of a part of the body is used to decide the first reference direction, the control unit 108 decides the aspect of the notification corresponding to the information as an aspect of a reference object. In addition, a value such as importance may be set for each aspect and an aspect of notification may be decided in accordance with a sum of set values. In addition, the control unit 108 may control an aspect of notification related to a reference object. For example, apart from a reference object, the projection device 300 is caused to project a virtual object of which the aspect is changed, as described above, on the basis of an aspect of a part of the body used to decide the first reference direction. In addition, the virtual object may be a numerical value.

### 1.3. Process of Device

Next, a process of the information processing device 100 will be described.

### (Whole Process)

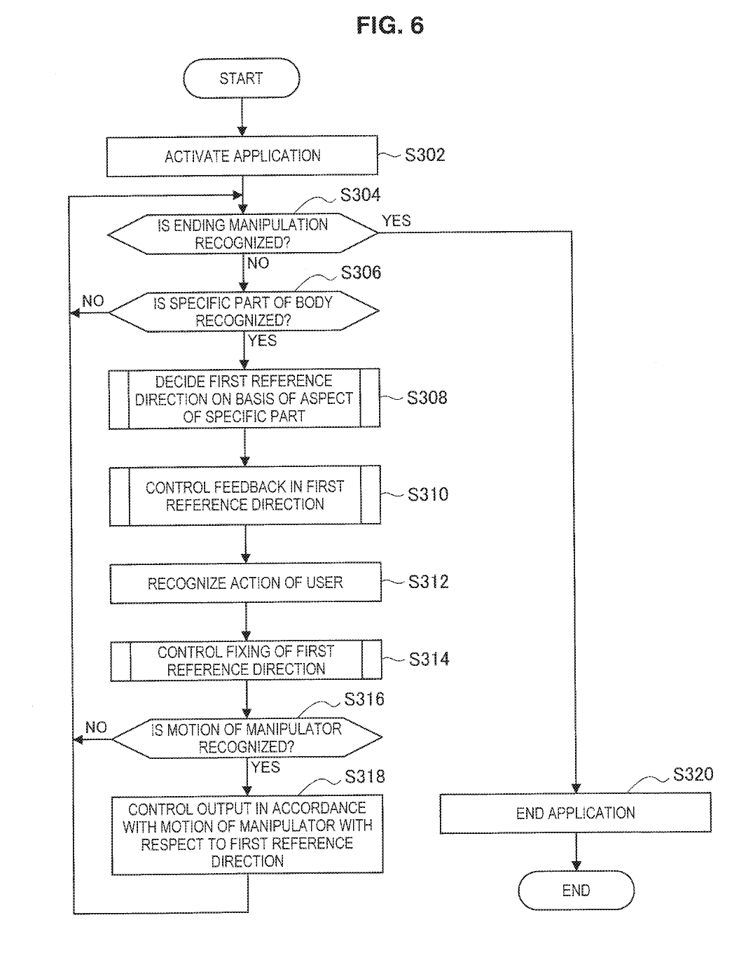

First, a whole process of the information processing device 100 will be described with reference to FIG. 6. FIG. 6 is a flowchart conceptually illustrating an example of a whole process of the information processing device 100 according to the embodiment of the present disclosure.

The information processing device 100 activates an application (step S302). Specifically, the control unit 108 activates the application in response to a user manipulation recognized by the recognition unit 104. Note that the application may be automatically activated.

Subsequently, the information processing device 100 determines whether an ending manipulation is recognized (step S304). Specifically, the control unit 108 determines whether the user manipulation recognized by the recognition unit 104 is an ending manipulation for the application.

When it is determined that the ending manipulation is not recognized (NO in step S304), the information processing device 100 determines whether the specific part of the body is recognized (step S306). Specifically, the decision unit 106 determines whether the recognition unit 104 recognizes the specific part of the body.

When it is determined that the specific part of the body is recognized (YES in step S306), the information processing device 100 decides the first reference direction on the basis of an aspect of the specific part (step S308). Specifically, the decision unit 106 decides the first reference direction on the basis of the recognized shape of the specific part or the positional relation.

Subsequently, the information processing device 100 controls feedback in the first reference direction (step S310). Specifically, the control unit 108 causes the projection device 300 to project the reference object indicating the first reference direction decided by the decision unit 106. Note that the details of this step will be described below.

Subsequently, the information processing device 100 recognizes an action of the user (step S312). Specifically, the recognition unit 104 recognizes a motion of the user after the first reference direction is decided.

Subsequently, the information processing device 100 controls the fixing of the first reference direction (step S314). Specifically, the decision unit 106 fixes the decided first reference direction when the recognition unit 104 recognizes the specific motion of the user. Note that the details of this step will be described below.

Subsequently, the information processing device 100 determines whether a motion of the manipulator is recognized (step S316). Specifically, the control unit 108 determines whether the recognition unit 104 recognizes the motion of the manipulator.

When it is determined that the motion of the manipulator is recognized (YES in step S316), the information processing device 100 controls an output in accordance with the motion of the manipulator with respect to the first reference direction (step S318). Specifically, the control unit 108 decides the manipulation direction and the manipulation amount on the basis of the motion of the manipulator recognized by the recognition unit 104 and the first reference direction. Then, the control unit 108 controls a projection position or the like of the virtual object in accordance with the decided manipulation direction and manipulation amount.

Note that when it is determined that the ending manipulation is recognized (YES in step S304), the information processing device 100 ends the application (step S320) and ends the process.

### (Feedback Control in First Reference Direction)

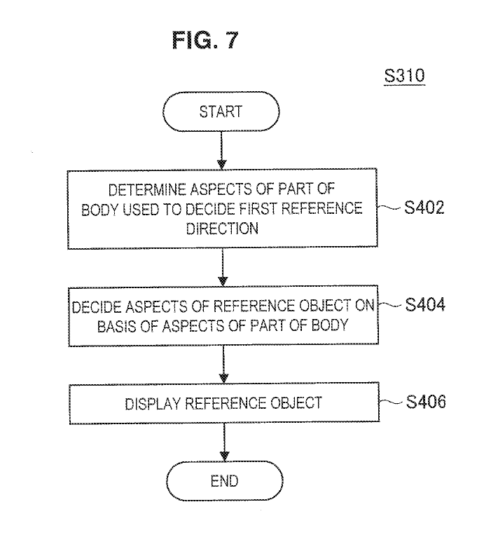

Next, a feedback control process in the first reference direction in the information processing device 100 will be described with reference to FIG. 7. FIG. 7 is a flowchart conceptually illustrating an example of a feedback control process in the first reference direction in the information processing device 100 according to the embodiment of the present disclosure.

The information processing device 100 determines the aspects of the part of the body used to decide the first reference direction (step S402). Specifically, the control unit 108 calculates the number of aspects of the part of the body used to decide the first reference direction.

The information processing device 100 decides the aspects of the reference object on the basis of the aspects of the part of the body (step S404). Specifically, the control unit 108 selects the aspect of the reference object corresponding to the number of aspects of the part of the body used to decide the first reference direction.

Subsequently, the information processing device 100 causes an external device to display the reference object (step S406). Specifically, the control unit 108 causes the projection device 300 to project the reference object in the selected aspect of the reference object.

### (Fixing Control in First Reference Direction)

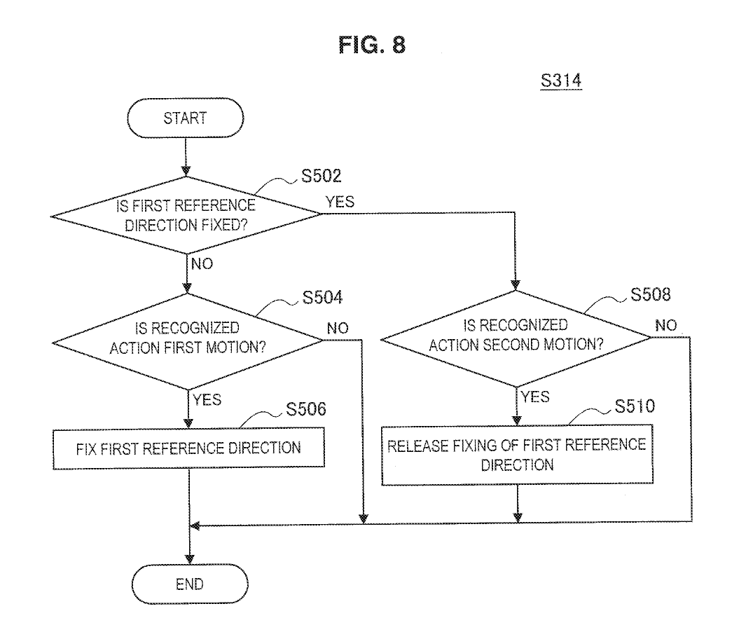

Next, a fixing control process in the first reference direction in the information processing device 100 will be described with reference to FIG. 8. FIG. 8 is a flowchart conceptually illustrating an example of a fixing control process in the first reference direction in the information processing device 100 according to the embodiment of the present disclosure.

The information processing device 100 determines whether the first reference direction is fixed (step S502). Specifically, the decision unit 106 determines whether the decided first reference direction is fixed.

When it is determined that the first reference direction is not fixed (NO in step S502), the information processing device 100 determines whether the recognized action is a first motion (step S504). Specifically, when it is determined that the first reference direction is not fixed, the decision unit 106 determines whether the motion of the user recognized by the recognition unit 104 is the first motion, that is, a motion for giving an instruction to fix the first reference direction.

When it is determined that the recognized action is the first motion (YES in step S504), the information processing device 100 fixes the first reference direction (step S506). Specifically, when it is determined that the motion of the user is the first motion, the decision unit 106 fixes the decided first reference direction in accordance with an attitude of the part of the body at the current time point.

In addition, when it is determined that the first reference direction is fixed (YES in step S502), the information processing device 100 determines whether the recognized action is a second motion (step S508). Specifically, when it is determined that the first reference direction is not fixed, the decision unit 106 determines whether the motion of the user recognized by the recognition unit 104 is the second motion, that is, a motion for giving an instruction to release the fixing of the first reference direction.

When it is determined that the recognized action is the second motion (YES in step S508), the information processing device 100 releases the fixing of the first reference direction (step S510). Specifically, when it is determined that the motion of the user recognized by the recognition unit 104 is the second motion, the decision unit 106 releases the fixing of the first reference direction.

### 1.4. Operation Example

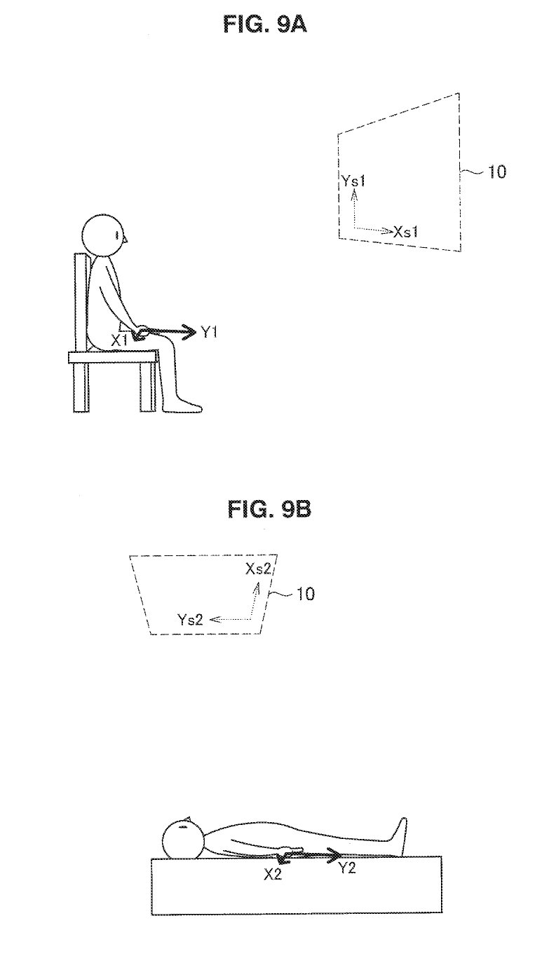

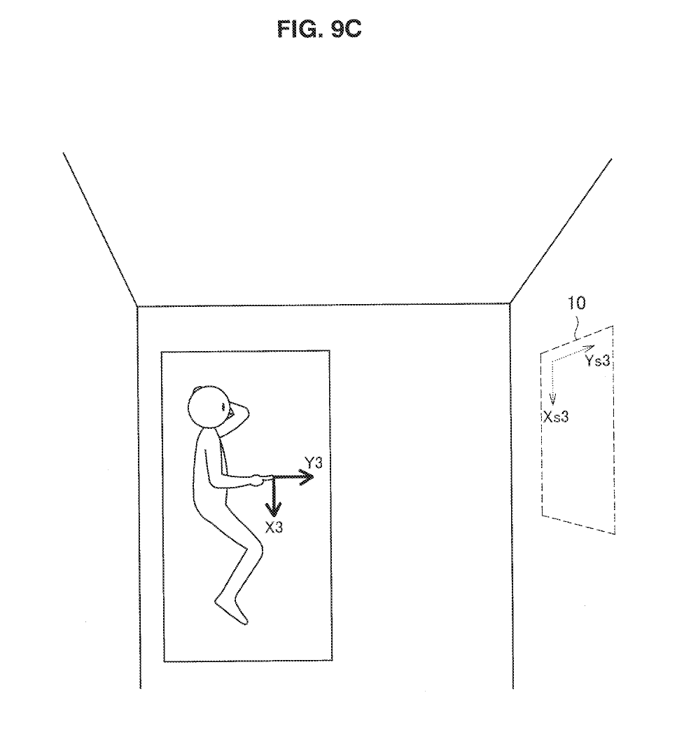

The information processing system and the information processing device 100 according to the embodiment have been described above. Next, operation examples of the information processing device 100 will be described with reference to FIGS. 9A to 9C. FIGS. 9A to 9C are explanatory diagrams illustrating each operation example of the information processing device 100 according to the embodiment of the present disclosure.

First, an example in which the user of the information processing device 100 performs a manipulation in a sitting state will be described. For example, as illustrated in FIG. 9A, a case in which the user performs a manipulation with a hand using a thigh of the user as a manipulation surface in a state in which the user is sitting on a chair or the like will be considered. In this case, an aspect of the hand of the user is first recognized from a measurement result of the measurement device 200. Then, on the basis of the aspect of the hand of the user, the first reference direction is decided as an X1 axis and a Y1 axis of a surface which is a planar portion of the thigh of the user, as illustrated in FIG. 9A. With the attitude of the user, it is natural to put the hand on the thigh of the user and a burden is small. Here, the directions of the X1 axis and the Y1 axis are different from those of an Xs1 axis and a Ys1 axis, but the X1 axis and the Y1 axis are mapped to the Xs1 axis and the Ys1 axis, respectively. Therefore, for example, when the user moves his or her hand in the Y1 axis direction, a manipulation on the projection region 10 is performed in the Ys1 axis direction. Accordingly, the user can perform the manipulation with the natural attitude.

Next, an example in which the user of the information processing device 100 performs a manipulation in a face-up state will be described. For example, as illustrated in FIG. 9B, a case in which the user performs a manipulation with his or her hand using a bed or the like as a manipulation surface in a state in which the user lies face up on the bed is considered. In this case, an aspect of the hand of the user is first recognized from a measurement result of the measurement device 200. Then, on the basis of the aspect of the hand of the user, the first reference direction is decided as an X2 axis and a Y2 axis of a surface which is a planar portion of the bed, as illustrated in FIG. 9B. The Y2 axis direction is an opposite direction to a direction oriented toward the head of the user. With this attitude of the user, it is natural to put the hand on the bed and a burden is small. Here, the directions of the X2 axis and the Y2 axis are also different from those of an Xs2 axis and a Ys2 axis with respect to the projection region 10, but the X2 axis and the Y2 axis are mapped to the Xs2 axis and the Ys2 axis, respectively. Therefore, for example, when the user moves his or her hand in the Y2 axis direction, a manipulation on the projection region 10 is performed in the Ys2 axis direction.

Next, an example in which the user of the information processing device 100 performs a manipulation in a lying state will be described. For example, as illustrated in FIG. 9C, a case in which the user performs a manipulation with his or her hand using a bed or the like as a manipulation surface in a state in which the user lies on the bed is considered. In this case, an aspect of the hand of the user is first recognized from a measurement result of the measurement device 200. Then, on the basis of the aspect of the hand of the user, the first reference direction is decided as an X3 axis and a Y3 axis of a surface which is a planar portion of the bed, as illustrated in FIG. 9C. The Y3 axis direction is a direction oriented toward the projection region 10. With this attitude of the user, it is natural to put the hand on the bed and a burden is small. Here, the direction of the Y3 axis is also different from those of a Ys3 axis of the projection region 10, but the X3 axis and the Y3 axis are mapped to the Xs3 axis and the Ys3 axis, respectively. Therefore, for example, when the user moves his or her hand in the Y3 axis direction, a manipulation on the projection region 10 is performed in the Ys3 axis direction.

### 1.5. Summary of Embodiment of Present Disclosure

In this way, according to the embodiment of the present disclosure, the information processing device 100 decides the first reference direction of a manipulation by a manipulator on the basis of the information regarding the aspect of a part of the body of the user and controls an output related to the manipulation in accordance with the information regarding a motion of the manipulator with respect to the decided first reference direction.

In the related art, a reference direction of a manipulation was set and fixed in a device. Therefore, a user of the device had to ascertain the set reference direction and perform the manipulation in accordance with the reference direction. In particular, since the direction of the display screen and the reference direction of the manipulation are generally mapped in a manipulation of a display device, for example, the user had to change his or her attitude in accordance with the direction of the display screen to change a way of a manipulation. In addition, the display screen and a manipulator such as a touch pad have recently been separated from each other, and thus the manipulator can be disposed freely. On the other hand, since mapping between the direction of the direction screen and the reference direction of the manipulation is fixedly maintained, a sense of manipulation by the user and a behavior of an actual manipulation may be mismatched and a different manipulation from a manipulation intended by the user may be performed. Thus, there is concern of the user being confused about a manipulation result or feeling uncomfortable.

In contrast, the information processing device 100 can decide the first reference direction of the manipulation in conformity to a user so that the user can perform a manipulation without being aware of the setting of a device. Accordingly, the user can perform a manipulation more freely compared to the related art, and thus it is possible to reduce a burden on the manipulation. For example, irrespective of any state of the user such as a standing state or a lying state, the user can manipulate a device with substantially the same sense of manipulation. In addition, the user can focus on content of the manipulation, and thus it is possible to prevent a failure of the manipulation. Further, the first reference direction suitable for the user can be decided so that the user can become accustomed to mastering of the manipulation. In this way, it is possible to reduce stress which the user feels in the manipulation of the device.

In addition, the aspects of the part of the body include a shape of the part of the body. Therefore, it is possible to decide the first reference direction close to the reference direction of a manipulation intended by the user. For example, in a case in which the part of the body is a hand, there is a possibility that a direction in which a finger is stretched is a main direction of the manipulation. Therefore, by deciding the direction in which the finger is stretched as the first reference direction, it is possible to decide the first reference direction appropriate for the manipulation by the user.

In addition, the information processing device 100 decides the first reference direction on the basis of a shape of a region decided from the information regarding the shape of the part of the body. Therefore, it is possible to simplify a process more than in a case in which the first reference direction is decided on the basis of the shape. Accordingly, it is possible to reduce a processing load and a processing speed of the information processing device 100.

In addition, the aspects of the part of the body include a positional relation between the first part and the second part adjacent to the first part. Therefore, by deciding the first reference direction from the positional relation between the recognized parts, it is possible to improve the degree of appropriateness of the first reference direction even in a case in which it is difficult to recognize the shape of the part of the body. Accordingly, it is possible to prevent discomfort of the user with respect to the decided first reference direction.

In addition, the manipulator includes a part of the body. Therefore, the user can intuitively perform a manipulation without checking a manipulation source. In addition, from another viewpoint, it is possible to omit labor for preparing a manipulator. Accordingly, it is possible to shorten a time until the user performs a desired manipulation.

In addition, the first reference direction is fixed on the basis of the information regarding an action of the user on a target of a manipulation by a manipulator. Here, there is a possibility of the aspects of the body of the user being changed during a manipulation. The user is considered not to desire a change in the first reference direction due to this change. On the other hand, when the first reference direction is automatically fixed, there is concern of difference from an intention of the user. Accordingly, by fixing the first reference direction on the basis of an action of the user, it is possible to fix the first reference direction in a direction conforming to the intention of the user. Accordingly, it is possible to improve usability.

In addition, an action of the user includes an action involving a motion of the user. Therefore, the recognition process of the recognition unit 104 can be used to fix the first reference direction. Accordingly, it is possible to realize the fixing of the first reference direction conforming to an intention of the user without adding a function.

In addition, the information processing device 100 further controls an output of notification with respect to the decided first reference direction. Therefore, the user can ascertain the first reference direction. Accordingly, it is possible to prevent a manipulation from being performed in the first reference direction different from a direction intended by the user, and it is possible to prevent the manipulation from being reattempted.

In addition, the information processing device 100 controls an aspect of the notification on the basis of the information regarding the aspect of the part of the body used to decide the first reference direction. For example, in a case in which a plurality of aspects are used to decide the first reference direction or an aspect with which it is easier to specify a direction conforming to an intention of the user than with the other aspects is used to decide the first reference direction, there is a high possibility of the decided first reference direction being appropriate. Conversely, otherwise, there is concern of the decided first reference direction being inappropriate. Thus, by suggesting to the user that the user can obtain sufficient information to decide the first reference direction, the information processing device 100 can prompt the user to change an aspect or the like so that information for deciding the first reference direction can be additionally obtained.

In addition, the notification includes display of a virtual object indicating the first reference direction. Therefore, by presenting the first reference direction as visual information which is easily recognized by the user, the user can be caused to be aware of the first reference direction. Note that the notification may be an output of sound or tactile vibration or a plurality of notifications may be combined.

### 1.6. Modification Examples

The embodiment of the present disclosure has been described above. Note that the embodiment of the present disclosure is not limited to the above-described example. Hereinafter, first to seventh modification examples of the embodiment of the present disclosure will be described.

### First Modification Example

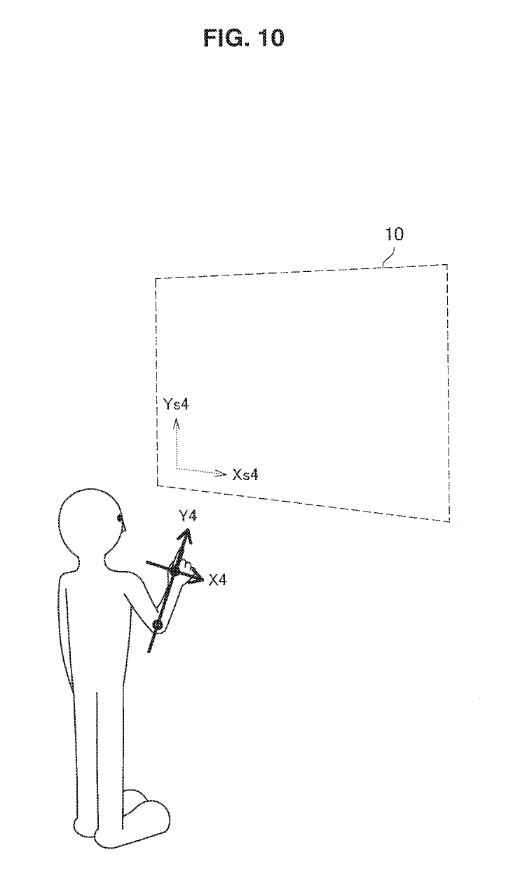

According to a first modification example of the embodiment of the present disclosure, an aspect of a part of the body related to decision of the first reference direction may be a positional relation between the first part and the second part related to a movable range of the first part. Specifically, the recognition unit 104 recognizes the first part and the second part which is a supporting point of the first part. Then, the decision unit 106 decides a straight line connecting the recognized first part and second part as the first reference direction. Further, a process according to the modification example will be described in detail with reference to FIG. 10. FIG. 10 is an explanatory diagram illustrating an example of a method of deciding the first reference direction in the information processing device 100 according to the first modification example of the embodiment of the present disclosure.

The recognition unit 104 recognizes the first part of the body and the second part which is a supporting point of the first part. For example, the recognition unit 104 recognizes a forearm that has a hand and an elbow, as illustrated in FIG. 10. In addition, the position of the hand and the position of the elbow are also recognized.

When the first part and the second part of the body are recognized, the decision unit 106 decides the first reference direction on the basis of a positional relation between the recognized first part and second part. For example, the decision unit 106 decides a straight line connecting the position of the hand and the position of the elbow, as illustrated in FIG. 10, as a Y4 axis direction serving as the first reference direction. Note that a direction oriented from the elbow to the hand is decided as the positive direction of the Y4 axis. In addition, the decision unit 106 decides a direction orthogonal to the Y4 axis and the hand as an X4 axis direction serving as the first reference direction.

Note that, in the example of FIG. 10, the decision unit 106 may decide the first reference direction on the basis of a shape of the forearm of the user recognized by the recognition unit 104.

In this way, according to the first modification example of the embodiment of the present disclosure, the aspect of the part of the body related to the decision of the first reference direction includes the positional relation between the first part and the second part related to the movable range of the first part. Here, the movable range of the part of the body is decided in accordance with a part which is a supporting point of movement of the part of the body. That is, the part of the body in which a part serving as the supporting point is a starting point is moved. On the other hand, even in a case in which a part of the body is a manipulator or an instrument is a manipulator, a manipulation is performed using the part of the body of the user. Accordingly, the part (the first part) of the body related to the manipulation is moved using the part (the second part) of the body which is the supporting point of the first part as the starting point. Thus, by deciding the first reference direction from the positional relation between the first part and the second part which is the supporting point of the first part as in the modification example, it is possible to improve a possibility of a manipulation being completed within the movable range of the first part. Accordingly, a manipulation amount can be approximated to a more appropriate amount.

### Second Modification Example

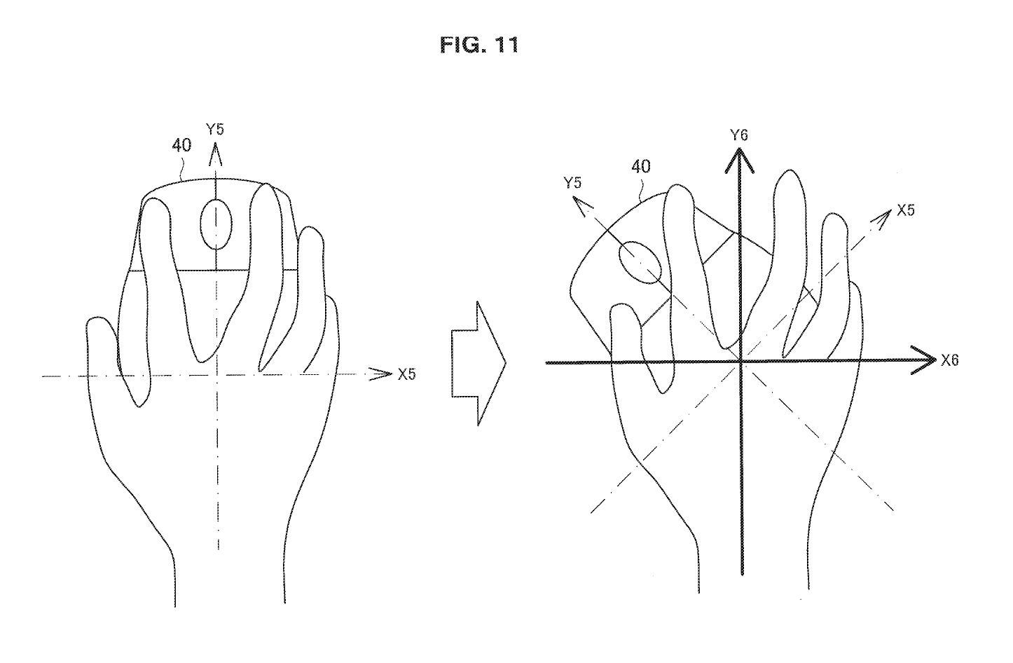

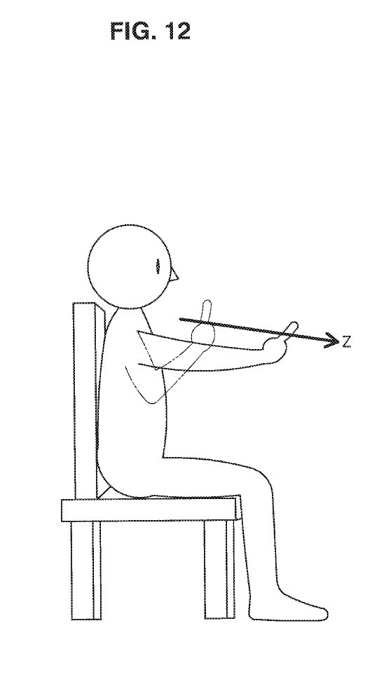

According to a second modification example of the embodiment of the present disclosure, an aspect of a part of the body related to decision of the first reference direction may be another aspect different from the above-described aspect. Specifically, the aspect of the part of the body includes an aspect of gripping of a manipulator by a part that grips the manipulator. For example, the recognition unit 104 recognizes an aspect of a hand that grips the manipulator. Then, the decision unit 106 decides the first reference direction on the basis of the aspect of the recognized hand. A process according to the modification example will be described in detail with reference to FIG. 11. FIG. 11 is an explanatory diagram illustrating an example of the method of deciding the first reference direction in the information processing device 100 according to the second modification example of the embodiment of the present disclosure.

The recognition unit 104 recognizes an aspect of a part of the body that grips a manipulator. Specifically, the manipulator includes a sensor that detects a touch of another object (for example, a hand) such as a pressure sensor. The recognition unit 104 recognizes the aspect of the part of the body that grips the manipulator on the basis of touch information obtained from the pressure sensor via the communication unit 102. For example, as illustrated in the right drawing of FIG. 11, a mouse 40 which is a manipulator includes a sensor that detects positions of fingers of the hand that grips the mouse 40. The recognition unit 104 recognizes the detected positions of the fingers.

Subsequently, the decision unit 106 decides the first reference direction on the basis of the aspect of the part of the body that grips the recognized manipulator. For example, the decision unit 106 ascertains a stretching direction of the hand from the recognized positions of the fingers and decides the ascertained stretching direction as a Y6 axis direction serving as the first reference direction. In addition, the decision unit 106 decides a direction orthogonal to the Y6 axis and a central portion of the hand as an X6 axis direction.

Further, the control unit 108 may switch between the first reference direction and the second reference direction of a manipulation by an object different from the body and serving as the manipulator in control of an output related to the manipulation by the manipulator. Specifically, the decision unit 106 switches between the first reference direction and the second reference direction set in the object serving as the manipulator on the basis of a change in the aspect of the part of the body. Further, an example of a method of deciding the first reference direction based on the second reference direction will be described with reference to FIG. 11.

The control unit 108 controls an output on the basis of the second reference direction of the manipulator in a case in which the first reference direction is not set. For example, in a case in which the decision unit 106 does not set the first reference direction, the control unit 108 controls an output of a manipulation on the basis of a Y5 axis and an X5 axis serving as the second reference direction set for the mouse 40, as illustrated in the left drawing of FIG. 11.

The decision unit 106 determines whether the aspect of the manipulator recognized by the recognition unit 104 is changed. For example, the decision unit 106 determines that the aspect of the manipulator is changed when the recognition unit 104 recognizes that the manipulator is caused to be moved straightly and subsequently recognizes that the manipulator starts to be rotated and the movement of the manipulator deviates from a straight line. The rotation of the manipulator is rotation on a wrist, an elbow, a shoulder, or the like of the user manipulating the manipulator in many cases. Note that a state of the manipulator may be recognized on the basis of the second reference direction and manipulation information obtained from the manipulator or may be recognized through a recognition process based on 3-dimensional information.

When it is determined that the recognized aspect of the manipulator is changed, the decision unit 106 decides the first reference direction on the basis of an aspect of a specific part of the body manipulating the manipulator. For example, when it is determined that the aspect of the manipulator is changed, the decision unit 106 decides the Y6 axis direction and the X6 axis direction serving as the first reference direction on the basis of an aspect of a hand of the user manipulating the manipulator.

When the first reference direction is decided, the control unit 108 controls the output on the basis of the first reference direction instead of the second reference direction. For example, when the decision unit 106 determines the first reference direction, the control unit 108 controls the output of the manipulator by the manipulator using the X6 axis direction and the Y6 axis direction serving as the first reference direction instead of the X5 axis direction and the Y5 axis direction serving as the second reference direction.

Note that instead of the second reference direction, the first reference direction may normally be applied to the process of the manipulation by the manipulator.

In addition, the aspect of the part of the body may be a movement of the part of the body. Specifically, the recognition unit 104 recognizes a movement of a specific part of the body of the user. Then, the decision unit 106 decides a direction which is ascertained on the basis of the recognized movement of the specific part of the body as the first reference direction. A process of deciding the first reference direction based on the movement of the specific part of the body will be described in detail with reference to FIG. 12. FIG. 12 is an explanatory diagram illustrating another example of the method of deciding the first reference direction in the information processing device 100 according to the second modification example of the embodiment of the present disclosure.

The recognition unit 104 recognizes the movement of the specific part of the body. For example, as illustrated in FIG. 12, the recognition unit 104 recognizes a position of a hand of the user and recognizes a movement of the hand on the basis of a change in the recognized position of the hand. Note that the movement of the specific part of the body may be recognized on the basis of a change in a distance to a predetermined position instead of being recognized as the change in the position. For example, when a distance between a virtually set predetermined surface and the hand of the user decreases, a movement of the hand in a direction oriented from the user to the predetermined surface is recognized.

Subsequently, the decision unit 106 decides the first reference direction on the basis of the recognized movement of the specific part of the body. For example, the decision unit 106 ascertains a movement direction of the hand from the recognized movement of the hand and decides the ascertained movement direction of the hand as the Z axis direction serving as the first reference direction, that is, a depth direction. Note that the X axis direction and the Y axis direction may be further decided from a shape or the like of the hand.

In this way, according to the second modification example of the embodiment of the present disclosure, the part of the body includes a part that grips a manipulator and the aspect of the part of the body includes an aspect of gripping of the manipulator. Therefore, even in a case in which the part of the body is not able to be intuitively recognized, the first reference direction can be decided. Accordingly, it is possible to reduce stress on a manipulation by the user in more situations.

In addition, the manipulator includes a different object from the body. In the control of the output related to the manipulation, the first reference direction and the second reference direction of the manipulation by the object are switched. Here, accuracy or precision of the manipulation by the manipulator is ensured to some extent. Therefore, in a case in which a manipulation intended by the user is estimated to be realized, there is a possibility of use of the second reference direction set for the manipulator being advantageous. Accordingly, by switching between the first reference direction and the second reference direction depending on a situation, it is possible to further facilitate realization of the manipulation intended by the user.

In addition, the aspect of the part of the body includes a movement of the part of the body. Here, in a case in which the first reference direction is decided from the shape or the like of the part of the body, the user is not conscious of deciding the first reference direction. Therefore, there is concern of the first reference direction being determined to be a direction not intended by the user while the user is not accustomed. Accordingly, by deciding the first reference direction on the basis of the movement of the part of the body, it is possible to improve a possibility of the determined first reference direction further conforming to the intention of the user than in a case in which the part of the body is at standstill. Accordingly, it is possible to improve usability of a manipulation.

### Third Modification Example

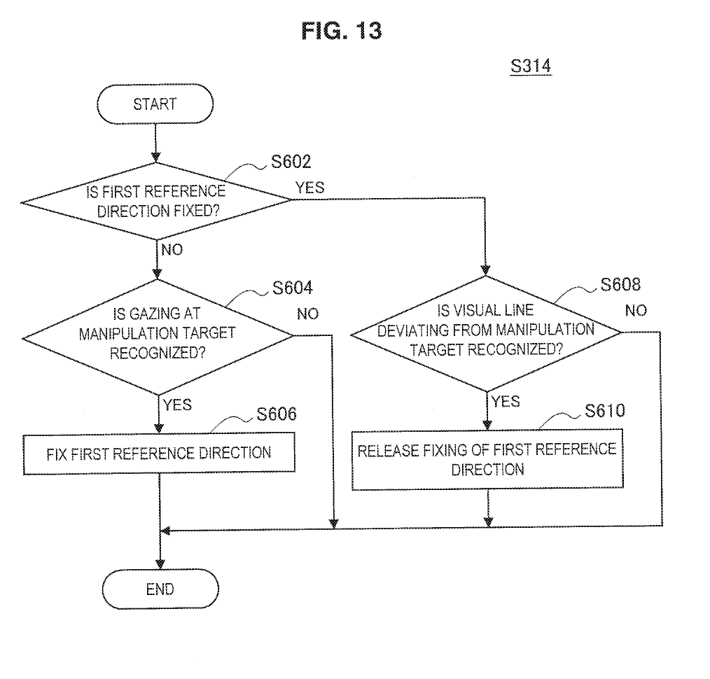

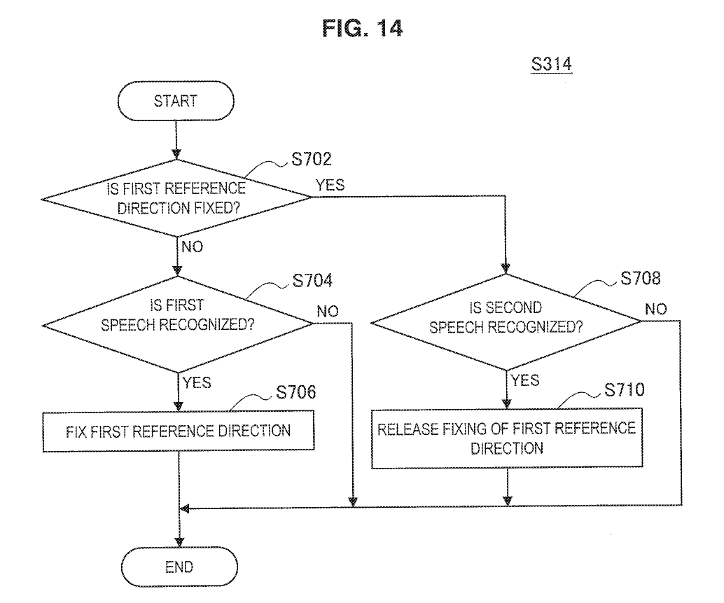

According to a third modification example of the embodiment of the present disclosure, the information regarding an action of the user used to control the fixing of the first reference direction may be information regarding an action not involving a motion of the user. Specifically, as the action not involving the motion of the user, there is a change in a visual line of the user. For example, the recognition unit 104 recognizes a visual line of the user and further recognizes a change or a non-change in the visual line or an aspect in the change. Then, the decision unit 106 controls the fixing of the first reference direction on the basis of the change or non-change in the visual line recognized by the recognition unit 104 or the aspect of the change. Further, the control of the fixing of the first reference direction based on the change in the visual line of the user will be described in detail with reference to FIG. 13. FIG. 13 is a flowchart conceptually illustrating an example of the fixing control process in the first reference direction in the information processing device 100 according to the third modification example of the embodiment of the present disclosure. Note that the description of substantially the same process as the above-described process will be omitted.

The information processing device 100 determines whether the first reference direction is fixed (step S602).

When it is determined whether the first reference direction is not fixed (NO in step S602), the information processing device 100 determines whether gazing a manipulation target is recognized (step S604). Specifically, when it is determined that the first reference direction is not fixed, the decision unit 106 determines whether the recognition unit 104 recognizes that the visual line of the user to the manipulation target (for example, a display screen) is not changed, that is, the user is gazing at the display screen, for a predetermined time.

When it is determined that the gazing at the manipulation target is recognized (YES in step S604), the information processing device 100 fixes the first reference direction (step S606). Conversely, in a case in which it is determined that the gazing at the manipulation target is not recognized (NO in step S604), a manipulation is estimated not to be yet prepared to be performed. Therefore, the first reference direction is not fixed.

Conversely, when it is determined that the first reference direction is fixed (YES in step S602), the information processing device 100 determines that the visual line deviating from the manipulation target is recognized (step S608). Specifically, when it is determined that the first reference direction is not fixed, the decision unit 106 determines whether the visual line of the user recognized by the recognition unit 104 deviates from the manipulation target for a predetermined time.

When it is determined that the visual line deviating from the manipulation target is recognized (YES in step S608), the information processing device 100 releases the fixing of the first reference direction (step S610). Specifically, when it is determined that the recognized visual line of the user deviates from the manipulation target for the predetermined time, the decision unit 106 releases the fixing of the first reference direction. Conversely, in a case in which it is determined that the visual line deviating from the manipulation target is not recognized (NO in step S608), it is estimated that the manipulation is still being performed. Therefore, the fixing of the first reference direction is not released.

The example in which the control of the fixing of the first reference direction is performed on the basis of the change in the visual line of the user has been described above. However, an action of the user may be a speech of the user. Specifically, the recognition unit 104 recognizes presence or absence of the speech of the user or an aspect of the speech. Then, the decision unit 106 controls the fixing of the first reference direction on the basis of the presence or absence of the speech recognized by the recognition unit 104 or the aspect of the speech. Note that the presence or absence of the speech or the aspect of the speech may be recognized on the basis of sound information obtained from a sound collection unit separately included in the information processing device 100 or an external sound reception device of the information processing device 100. In addition, the presence or absence of the speech or the aspect of the speech may be recognized on the basis of an image in which the face or the mouth of the user is shown and which is obtained from an imaging unit separately included in the information processing device 100 or an external imaging device of the information processing device 100. Further, the control of the fixing of the first reference direction based on a speech of the user will be described in detail with reference to FIG. 14. FIG. 14 is a flowchart conceptually illustrating another example of the fixing control process in the first reference direction in the information processing device 100 according to the third modification example of the embodiment of the present disclosure. Note that the description of substantially the same processes as the above-described processes will be omitted.

The information processing device 100 determines whether the first reference direction is fixed (step S702).

When it is determined whether the first reference direction is not fixed (NO in step S702), the information processing device 100 determines whether a first speech is recognized (step S704). Specifically, when it is determined that the first reference direction is not fixed, the decision unit 106 determines whether the recognition unit 104 recognizes the first speech (for example, a speech of a key word).

When it is determined that the first speech is recognized (YES in step S704), the information processing device 100 fixes the first reference direction (step S706). Conversely, in a case in which it is determined that the first speech is not recognized (NO in step S704), a manipulation is assumed to be still unprepared to be performed. Therefore, the first reference direction is not fixed.

In addition, when it is determined that the first reference direction is fixed (YES in step S702), the information processing device 100 determines whether a second speech is recognized (step S708). Specifically, when it is determined that the first reference direction is not fixed, the decision unit 106 determines whether the recognition unit 104 recognizes the second speech (for example, a speech of another keyword) different from the first speech.

When it is determined that the second speech is recognized (YES in step S708), the information processing device 100 releases the fixing of the first reference direction (step S710). Conversely, in a case in which it is determined that the second speech is not recognized (NO in step S708), it is estimated that a manipulation is still being performed. Therefore, the fixing of the first reference direction is not released.

In this way, according to the third modification example of the embodiment of the present disclosure, an action of the user related to the control of the fixing of the first reference direction includes a change in a visual line of the user or a speech of the user as an action not involving a motion of the user. Therefore, it is possible to fix the first reference direction although the user does not move. Accordingly, it is possible to improve usability of a manipulation on the control of the fixing. For example, in a case in which a part of the body related to the decision of the first reference direction is a manipulator, the first reference direction can be fixed although the user does not move his or her body. Therefore, it is possible to prevent concern of the first reference direction being decided as a direction not intended by the user. In particular, in a case in which a visual line of the user is changed, there is a tendency to gaze a manipulation target when the user performs the manipulation. Therefore, it is possible to fix the first reference direction during a series of actions until the manipulation. In addition, in the case of a speech of the user, the user does not necessarily move a visual line to a manipulation target. Therefore, it is possible to fix the first reference direction while the user is working another work other than a manipulation by the manipulator.

### Fourth Modification Example

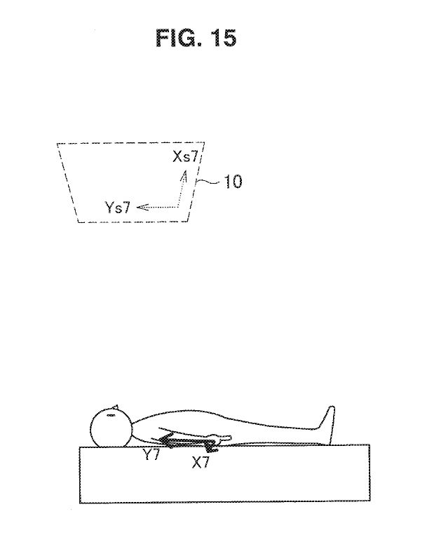

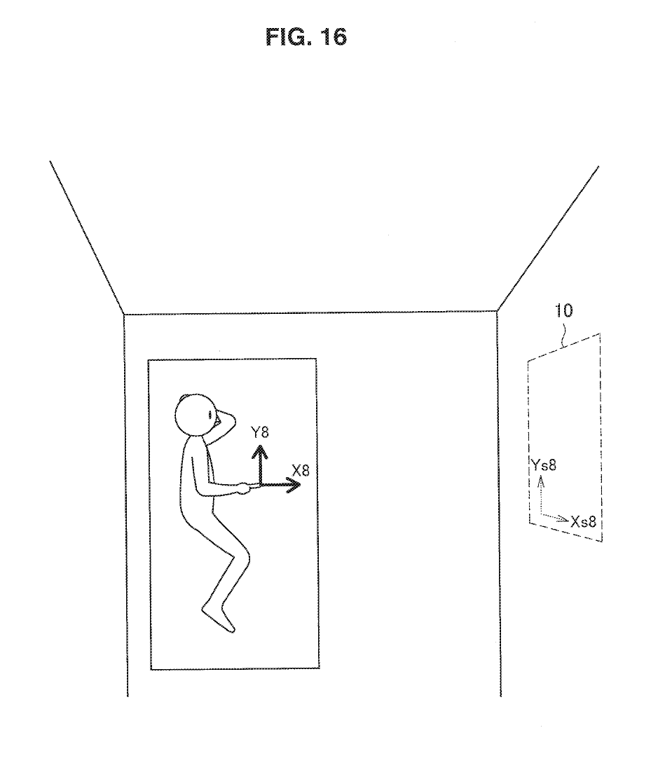

According to a fourth modification example of the embodiment of the present disclosure, the information processing device 100 may decide the first reference direction on the basis of another piece of information in addition to the information regarding an aspect of a part of the body. Specifically, the decision unit 106 may decide the first reference direction further on the basis of information regarding an attitude of the user. For example, the recognition unit 104 recognizes an attitude of the user with which the visual line of the user is estimated. Then, the decision unit 106 determines the first reference direction on the basis of a direction decided on the basis of the aspect of the part of the body of the user and the recognized attitude of the user. Further, the decision of the first reference direction based on the attitude and the aspect of the part of the body of the user will be described in detail with reference to FIGS. 9B and 15. FIG. 15 is an explanatory diagram illustrating an example of a method of deciding the first reference direction in the information processing device 100 according to the fourth modification example of the embodiment of the present disclosure.

The recognition unit 104 recognizes an aspect of a specific part of the body of the user and an attitude of the user. For example, the recognition unit 104 recognizes an aspect of a hand of the user and further recognizes an attitude with which the body of the user lies face up, as illustrated in FIG. 9B. Note that it may be recognized that the head of the user is oriented upwards.

Subsequently, the decision unit 106 temporarily decides the first reference direction on the basis of the recognized aspect of the specific part of the body. For example, the decision unit 106 decides the X2 axis and the Y2 axis as the temporarily first reference direction, as illustrated in FIG. 9B, on the basis of the recognized aspect of the hand.

Further, the decision unit 106 confirms the first reference direction on the basis of the temporarily decided first reference direction and the recognized attitude of the user. For example, the decision unit 106 changes the Y2 axis direction of the temporary first reference direction to an opposite direction from the recognized attitude of the user and decides an X7 axis direction and a Y7 axis direction, as illustrated in FIG. 15, as the first reference direction.

The example in which the first reference direction is decided on the basis of the attitude of the user has been described above. However, the information used to decide the first reference direction may be still another piece of information. Specifically, the decision unit 106 may decide the first reference direction on the basis of an aspect of a display screen related to a manipulation by a manipulator. For example, the recognition unit 104 recognizes the aspect of the display screen related to the manipulation by the manipulator. Then, the decision unit 106 decides the first reference direction on the basis of the direction decided on the basis of an aspect of the part of the body of the user and the recognized aspect of the display screen. Further, decision of the first reference direction based on the aspect of the part of the body of the user and the aspect of the display screen will be described in detail with reference to FIGS. 9C and 16. FIG. 16 is an explanatory diagram illustrating another example of the method of deciding the first reference direction in the information processing device 100 according to the fourth modification example of the embodiment of the present disclosure.

The recognition unit 104 recognizes the aspect of the specific part of the body of the user and the aspect of the display screen. For example, the recognition unit 104 recognizes an aspect of a hand of the user and further recognizes a direction of a screen projected to the projection region 10, as illustrated in FIG. 9C. Note that the direction of the screen may be recognized on the basis of control information managed by the control unit 108.

Subsequently, the decision unit 106 temporarily decides the first reference direction on the basis of the recognized aspect of the specific part of the body. For example, on the basis of the recognized aspect of the hand, the decision unit 106 decides the X3 axis and the Y3 axis, as illustrated in FIG. 9C, as the temporary first reference direction.

Further, the decision unit 106 settles the first reference direction on the basis of the temporarily decided first reference direction and the recognized aspect of the display screen. For example, the decision unit 106 changes the Y axis direction of the temporary first reference direction to an opposite direction from the recognized direction of the screen projected to the projection region 10 and decides an X8 axis direction and a Y8 axis direction, as illustrated in FIG. 16 as the first reference direction. Note that the aspect of the display screen may be estimated from an aspect of a virtual object displayed on the display screen.

In this way, according to the fourth modification example of the embodiment of the present disclosure, the information processing device 100 decides the first reference direction further on the basis of information regarding an attitude of the user or information regarding the aspect of the display screen related to a manipulation by a manipulator. Here, the reference direction of a manipulation desired by the user is different depending on an attitude of the user performing the manipulation in some cases. Accordingly, by considering the attitude of the user in addition of an aspect of a part of the body in decision of the first reference direction, the first reference direction can be approximated to the direction desired by the user.

In addition, the information processing device 100 decides the first reference direction further on the basis of an aspect of the display screen related to a manipulation by a manipulator. Here, in a case in which a manipulation target is a display screen, the reference direction of the manipulation desired by the user is different depending on an aspect of a direction or the like of the display screen in some cases. Accordingly, by considering the aspect of the display screen in addition to the aspect of the body in the decision of the first reference direction, the first reference direction can be approximated to the direction desired by the user.

### Fifth Modification Example

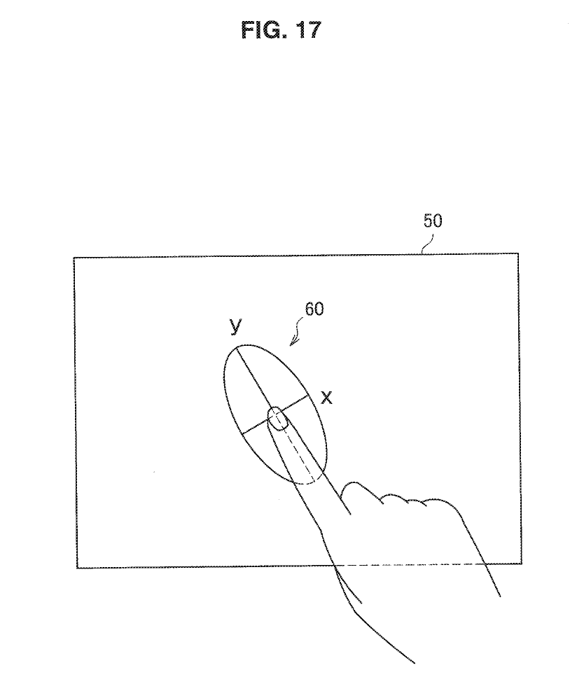

According to a fifth modification example of the embodiment of the present disclosure, a virtual object indicating the first reference direction may be displayed at a position corresponding to a position of a manipulation by a manipulator. Specifically, the control unit 108 causes a display device to display a reference object at a position selected by the manipulator. A display example of the reference object will be described with reference to FIG. 17. FIG. 17 is a diagram illustrating a display example of a reference object in the information processing device 100 according to the fifth modification example of the embodiment of the present disclosure. Note that a display device such as a touch panel is used instead of the projection device in FIG. 17.

When the first reference direction is decided, the recognition unit 104 recognizes a position selected by the manipulator. For example, when an aspect of a hand of the user touching a touch panel 50 is recognized, as illustrated in FIG. 17, and the first reference direction is decided on the basis of the aspect of the hand, the recognition unit 104 recognizes a position touched by the hand of the user. Note that the position selected by the manipulator may be ascertained through a recognition process using 3-dimensional information or may be recognized on the basis of information obtained from a device to be manipulated, such as the touch panel 50.

Subsequently, the control unit 108 causes the display device to display the reference object at the position selected by the manipulator. For example, when the position touched with the hand of the user is recognized, the control unit 108 causes the display device to display a reference object 60 illustrated in FIG. 17 on the touch panel 50 using the recognized position as a reference.

Note that the example in which the reference object is displayed at the position touched on the touch panel 50 is displayed has been described above, but the display of the reference object is not limited thereto. For example, the control unit 108 may cause the projection device 300 to project a virtual object indicating the position selected by the manipulator and may cause the reference object to be projected on the basis of a projection position of the virtual object.

In this way, according to the fifth modification example of the embodiment of the present disclosure, the virtual object indicating the first reference direction is displayed at the position corresponding to the position of the manipulation by the manipulator. Therefore, the reference object can be easily entered within a field of view of the user performing the manipulation. Accordingly, the user can be allowed to be easily aware of the reference object.

### Sixth Modification Example

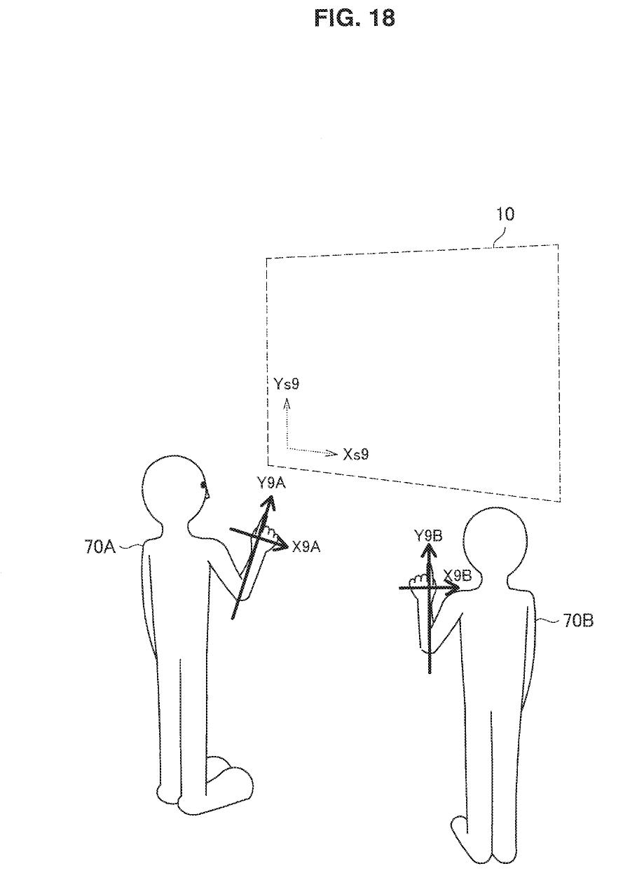

According to a sixth modification example of the embodiment of the present disclosure, the number of users of the information processing device 100 may be plural. Specifically, the decision unit 106 decides the first reference direction with regard to each of the plurality of users. Further, a process according to the modification example will be described in detail with reference to FIG. 18. FIG. 18 is an explanatory diagram illustrating an example in which the first reference direction is managed with regard to each of a plurality of users in the information processing device 100 in the sixth modification example of the embodiment of the present disclosure.

The recognition unit 104 recognizes each aspect of specific parts of the bodies of the plurality of users. For example, in a case in which there are two users 70A and 70B, as illustrated in FIG. 18, the recognition unit 104 recognizes a hand of each user.

Subsequently, when each aspect of the specific parts of the bodies of the plurality of users is recognized, the decision unit 106 determines the first reference direction with regard to each user. For example, the decision unit 106 decides an X9A axis direction and a Y9A axis direction and an X9B axis direction and a Y9B axis direction, as illustrated in FIG. 18, as the first reference direction on the basis of the recognized aspect of the hand with regard to each of the two users 70A and 70B.

Then, the control unit 108 controls an output on the basis of a manipulation of each user in the decided first reference direction. For example, the control unit 108 controls the output using the X9A axis and the Y9A axis in the manipulation by the user 70A and controls the output using the X9B axis and the Y9B axis in the manipulation by the user 70B.

In this way, according to the sixth modification example of the embodiment of the present disclosure, the information processing device 100 decides the first reference direction for each of the plurality of users. Therefore, each of the plurality of users can simultaneously perform the manipulation in the first reference direction. Accordingly, it is possible to increase a chance to apply the information processing device 100.

### Seventh Modification Example

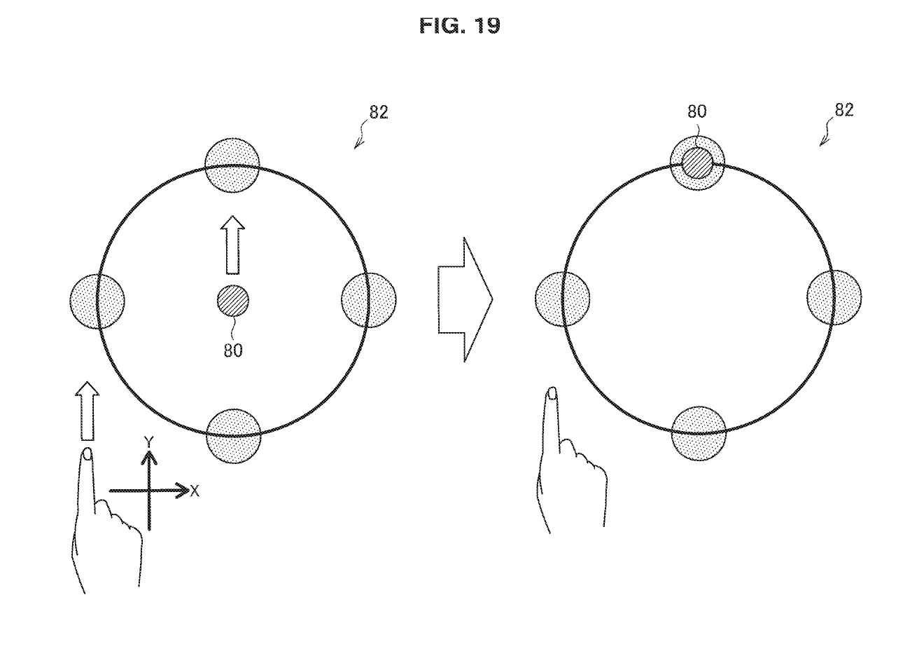

According to a seventh modification example of the embodiment of the present disclosure, the information processing device 100 may cause the user to experience a manipulation using the first reference direction before the user performs a desired manipulation. Specifically, when an application is activated, the control unit 108 causes a display device to display a predetermined screen. Then, the control unit 108 controls display of the predetermined screen in response to a manipulation by the user using the first reference direction decided on the basis of an aspect of a specific part of the body of the user. Further, a process of the modification example will be described in detail with reference to FIG. 19. FIG. 19 is an explanatory diagram illustrating an example of demonstration of a manipulation in the information processing device 100 according to the seventh modification example of the embodiment of the present disclosure.

When the application is activated, the control unit 108 first causes the display device to display a demonstration screen. For example, when the application is activated, the control unit 108 causes the projection device 300 to project a virtual object 80 and a plurality of virtual objects 82, as illustrated in the left drawing of FIG. 19. A projection position of the virtual object 80 is controlled in response to a manipulation by the user and projection positions of the virtual objects 82 are fixed.

Subsequently, the control unit 108 controls display of the demonstration screen for a manipulation by the user using the first reference direction decided on the basis of the recognized aspect of the specific part of the body of the user. For example, when the recognized hand of the user is moved in the positive direction of the Y axis which is the first reference direction, the control unit 108 causes the projection device 300 to move the virtual object 80 upwards, as illustrated in the left drawing of FIG. 19, and causes the virtual object 80 to be superimposed on one of the virtual objects 82, as illustrated in the right drawing of FIG. 19. In this case, when the virtual object 80 is moved in a direction intended by the user, the user can intuitively understand the first reference direction.

Note that the example in which only the demonstration is performed has been described above, but calibration may be further performed. For example, the control unit 108 presents a manipulation to be performed by the user on the demonstration screen to the user through the projection device 300 or another output device. Then, the control unit 108 corrects the first reference direction on the basis of a difference between actually performed manipulation and the presented manipulation on the demonstration screen.

In addition, the demonstration or the calibration may be performed at other timings different from start of the above-described manipulation. For example, when the recognition unit 104 recognizes that an attitude of the user or an attitude of the manipulator is changed, the control unit 108 may perform the foregoing demonstration or calibration.

In this way, according to the seventh modification example of the embodiment of the present disclosure, the information processing device 100 controls an output for causing the user to experience a manipulation. Therefore, the user can be aware of a difference between a sense of a manipulation by the user and an actual manipulation result before the user performs a desired manipulation. In particular, in a case in which the demonstration screen is displayed, the user can be allowed to be easily aware of the difference. Accordingly, it is possible to prevent concern of a manipulation failing when the user actually performs a desired manipulation.

### 2. HARDWARE CONFIGURATION OF INFORMATION PROCESSING DEVICE ACCORDING TO EMBODIMENT OF PRESENT DISCLOSURE

The information processing devices 100 according to an embodiment of the present disclosure have been described above. The processing performed by the information processing device 100 is achieved by cooperatively operating software and hardware of the information processing device 100 described below.

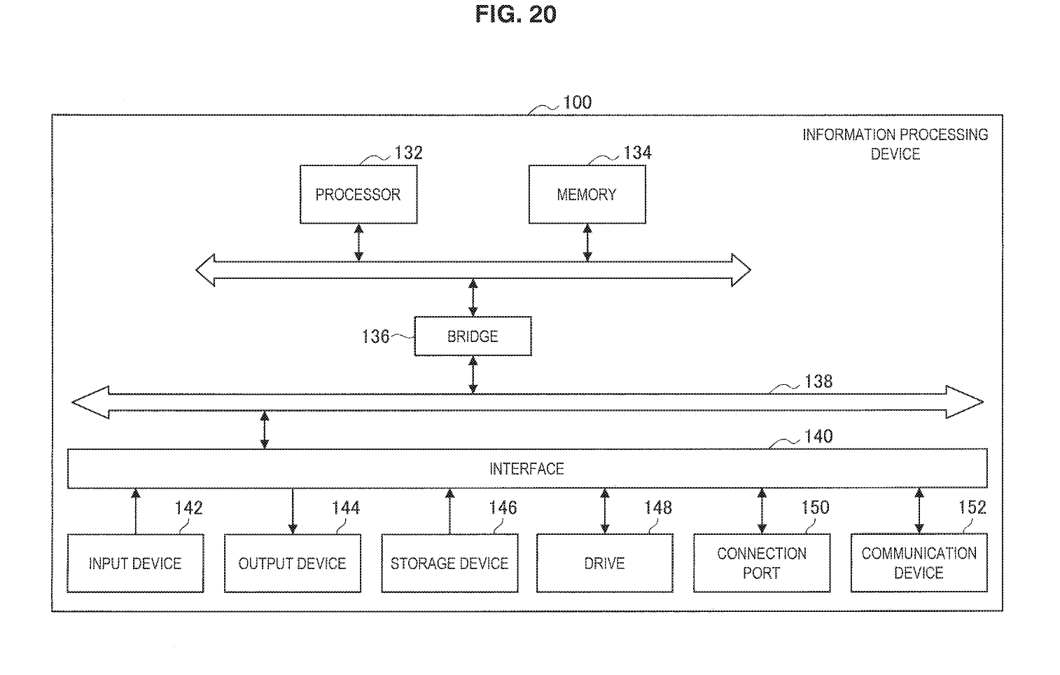

FIG. 20 is an explanatory diagram illustrating a hardware configuration of the information processing device 100 according to an embodiment of the present disclosure. As illustrated in FIG. 20, the information processing device 100 includes a processor 132, a memory 134, a bridge 136, a bus 138, an interface 140, an input device 142, an output device 144, a storage device 146, a drive 148, a connection port 150, and a communication device 152.

### (Processor)

The processor 132 functions as an arithmetic processing device, and achieves the functions of the speech recognition unit 104, the decision unit 106, and the control unit 108 in the information processing device 100 by cooperatively operating with various programs. The processor 132 causes various logical functions of the information processing device 100 to operate, by using a control circuit to execute programs stored in the memory 134 or another storage medium. For example, the processor 132 may be a central processing unit (CPU), a graphics processing unit (GPU), a digital signal processor (DSP), or a system on chip (SoC).

### (Memory)

The memory 134 stores a program, a calculation parameter, and the like used by the processor 132. For example, the memory 134 includes a random access memory (RAM), and transiently stores programs used for executing the processor 132, parameters or the like that change as appropriate when executing the processor 132. In addition, the memory 134 includes a read only memory (ROM), and functions as the storage unit by using the RAM and the ROM. Note that, an external storage device may be used as a part of the memory 134 via the connection port 150 or the communication device 152.

Note that, the processor 132 and the memory 134 are connected to each other via an internal bus including a CPU bus or the like.

### (Bridge and Bus)

The bridge 136 connects buses. Specifically, the bridge 136 connects the internal bus and the bus 138. The internal bus is connected to the processor 132 and the memory 134. The bus 138 is connected to the interface 140.

### (Input Device)

The input device 142 is used by a user for operating the information processing device 100 or inputting information to the information processing device 100. For example, the input device 142 includes an input means to which the user inputs information, and an input control circuit that generates an input signal on the basis of the user input and outputs the generated input signal to the processor 132. Note that, the input means may be a mouse, a keyboard, a touchscreen, a switch, a lever, a microphone, or the like. By operating the input unit 142, the user of the information processing device 100 can input various kinds of data into the information processing device 100 and instruct the information processing device 100 to perform a processing operation.

### (Output Device)

The display device 144 is used to notify a user of information, and realizes a function of an input/output unit. For example, the output device 144 may be a device such as a liquid crystal display (LCD) device, an organic light emitting diode (OLED) device, a projector, a speaker, or a headphone, or may be a module configured to output information to such a device.

Note that, the input device 142 or the output device 144 may include an input/output device. For example, the input/output device may be a touchscreen.

### (Storage Device)

The storage device 146 is a data storage device. The storage device 146 may include a storage medium, a recording device that records data on the storage medium, a reading device that reads data from the storage medium, a deletion device that deletes data recorded on the storage medium, and the like. The storage device 146 stores various kinds of data or a program to be executed by the CPU 132.

### (Drive)

The drive 148 is a reader/writer for a storage medium, and is incorporated in or externally attached to the information processing device 100. The drive 148 reads information stored in a removable storage medium that is mounted, such as a magnetic disk, an optical disc, a magneto-optical disk, or semiconductor memory, and outputs the information to the memory 134. The drive 148 is also capable of writing information to the removable storage medium.

### (Connection Port)

The connection port 150 is a port used to directly connect apparatuses to the information processing device 100. For example, the connection port 150 may be a USB (Universal Serial Bus) port, an IEEE1394 port, or a SCSI (Small Computer System Interface) port. In addition, the connection port 150 may be an RS-232C port, an optical audio terminal, an HDMI (registered trademark) (High-Definition Multimedia Interface) port, or the like. Data may be exchanged between the information processing device 100 and an external apparatus by connecting the external apparatus to the connection port 150.

### (Communication Device)

The communication device 152 mediates communication between the information processing device 100 and an external device, and functions as the communication unit 102. Specifically, the communication device 152 establishes communication in accordance with a wireless communication scheme or a wired communication scheme. For example, the communication device 152 establishes wireless communication in accordance with a cellular communication scheme such as Wideband Code Division Multiple Access (W-CDMA) (registered trademark), WiMAX (registered trademark), Long-Term Evolution (LTE), or LTE-A. Note that, the communication device 152 may establish wireless communication in accordance with any wireless communication scheme like a short-range wireless communication such as Bluetooth (registered trademark), near-field communication (NFC), wireless USB, or TransferJet (registered trademark), or a wireless local area network (LAN) such as Wi-Fi (registered trademark). In addition, the communication device 152 may establish wired communication such as signal line communication or wired LAN communication.

Note that, the information processing device 100 does not have to include a part of the structural elements described with reference to FIG. 20. In addition, the information processing device 100 may include any additional structural element. In addition, it is possible to provide a one-chip information processing module in which a part or all structural elements described with reference to FIG. 20 are integrated.

### 3. CONCLUSION

As described above, according to the embodiment of the present disclosure, it is possible to decide the first reference direction of the manipulation in conformity to a user so that the user can perform a manipulation without being aware of the setting of a device. Accordingly, the user can perform a manipulation more freely compared to the related art, and thus it is possible to reduce a burden on the manipulation. For example, irrespective of any state of the user such as a standing state or a lying state, the user can manipulate a device with substantially the same sense of manipulation. In addition, the user can focus on content of the manipulation, and thus it is possible to prevent a failure of the manipulation. Further, the first reference direction suitable for the user can be decided so that the user can become accustomed to mastering of the manipulation. In this way, it is possible to reduce stress which the user feels in the manipulation of the device.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the foregoing embodiment, the recognition process of the recognition unit 104 can be performed in the information processing device 100, but the present technology is not limited thereto. For example, the recognition process of the recognition unit 104 may be performed in an external device of the information processing device 100 and a recognition result may be acquired via the communication unit 102.

In addition, in the foregoing embodiment, the example in which the projection device 300 projects a manipulation target has mainly been described, but a manipulation target may be displayed on a display device other than the above-described touch panel. For example, a manipulation target may be displayed by a stationary display, a head-up display (HUD) in which light of an external world image is projected and an image is displayed on a display unit or image light related to an image is projected to the eyes of the user, a head mount display (HMD) in which a captured external world image and an image are displayed, or the like.

In addition, in the foregoing embodiment, the example in which the first reference direction is decided on the basis of one of a plurality of kinds of aspects of parts of the body has been described, but the first reference direction may be decided on the basis of two or more aspects among the plurality of aspects of the parts of the body. In this case, the decided first reference direction can be approximated to a direction intended by the user.

In addition, in the foregoing embodiment, the example in which the part of the body related to the decision of the first reference direction is a hand or an arm has been described, but the part of the body may be another part such as a leg or a head.

In addition, in the foregoing embodiment, the example in which the decision unit 106 performs the control process of the fixing of the first reference direction and the control unit 108 performs the process of switching between the first reference direction and the second reference direction has been described, but the process may be performed by one of the decision unit 106 and the control unit 108.

In addition, in the foregoing embodiment, the example in which the fixing of the first reference direction is released on the basis of an action of the user has been described, but the fixing of the first reference direction may be released when a predetermined time has passed. For example, when the predetermined time has passed from start of the fixing of the first reference direction, the decision unit 106 releases the fixing of the first reference direction.

In addition, in the foregoing embodiment, a scale of a control process for an output based on a manipulation in the control unit 108 has not been mentioned in detail, but the scale of the manipulation may be fixed or may be dynamically changed. Similarly, absoluteness or relativity of a position of a manipulation in the control process for the output may be fixed or may be dynamically changed. For example, the position of the manipulation by the user and the position of the display may be controlled absolutely at a start time point of the manipulation and may be controlled relatively after the start of the manipulation.

Further, the effects described in this specification are merely illustrative or exemplified effects, and are not limitative. That is, with or in the place of the above effects, the technology according to the present disclosure may achieve other effects that are clear to those skilled in the art from the description of this specification.

Further, not only a process in which steps shown in the flowcharts of the above embodiments are performed in a time-series manner in accordance with a described sequence but also a process in which the steps are not necessarily processed in a time-series manner but are executed in parallel or individually is included. Also, it is self-evident that even steps processed in a time-series manner can be appropriately changed in sequence depending on circumstances.

In addition, a computer program for causing hardware built in the information processing device 100 to exhibit functions equivalent to those of the above-described respective logical elements of the information processing device 100 can also be produced. Furthermore, a storage medium in which the computer program is stored is also provided.

Additionally, the present technology may also be configured as below.

(1)

An information processing device including:

a decision unit configured to decide a first reference direction of a manipulation by a manipulator on a basis of information regarding an aspect of a part of a body of a user; and

a control unit configured to control an output related to the manipulation in accordance with information regarding a motion of the manipulator with respect to the decided first reference direction.

(2)

The information processing device according to (1), in which the aspect of the part of the body includes a shape of the part of the body.

(3)

The information processing device according to (2), in which the decision unit decides the first reference direction on a basis of a shape of a region decided from information regarding the shape of the part of the body.

(4)

The information processing device according to (2) or (3), in which the aspect of the part of the body includes a positional relation between a first part and a second part adjacent to the first part.

(5)

The information processing device according to (4), in which the second part includes a part related to a movable range of the first part.

(6)

The information processing device according to any one of (1) to (5),

in which the part of the body includes a part that grips the manipulator, and

the aspect of the part of the body includes an aspect of gripping of the manipulator.

(7)

The information processing device according to any one of (1) to (6), in which the aspect of the part of the body includes movement of the part of the body.

(8)

The information processing device according to any one of (1) to (7), in which the manipulator includes a part of the body.

(9)

The information processing device according to any one of (1) to (8),

in which the manipulator includes an object different from the body, and

in the control of the output related to the manipulation, the first reference direction and a second reference direction of a manipulation by the object are switched.

(10)

The information processing device according to any one of (1) to (9), in which the first reference direction is fixed on a basis of information regarding an action of the user with respect to a target of a manipulation by the manipulator.

(11)

The information processing device according to (10), in which the action of the user includes an action involving a motion of the user or an action not involving a motion of the user.

(12)

The information processing device according to any one of (1) to (11), in which the control unit further controls an output of notification with respect to the decided first reference direction.

(13)

The information processing device according to (12), in which the control unit controls an aspect of the notification on a basis of information regarding the aspect of the part of the body used to decide the first reference direction.

(14)

The information processing device according to (12) or (13), in which the notification includes display of a virtual object indicating the first reference direction.

(15)

The information processing device according to (14), in which the virtual object is displayed at a position corresponding to a position of a manipulation by the manipulator.

(16)

The information processing device according to any one of (1) to (15), in which the decision unit decides the first reference direction further on a basis of information regarding an attitude of the user.

(17)

The information processing device according to any one of (1) to (16), in which the decision unit decides the first reference direction further on a basis of information regarding an aspect of a display screen related to a manipulation by the manipulator.

(18)

The information processing device according to any one of (1) to (17), in which the decision unit decides the first reference direction with regard to each of a plurality of users.

(19)

An information processing method including, by a processor:

deciding a first reference direction of a manipulation by a manipulator on a basis of information regarding an aspect of a part of a body of a user; and

controlling an output related to the manipulation in accordance with information regarding a motion of the manipulator with respect to the decided first reference direction.

(20)

A program causing a computer to realize:

a decision function of deciding a first reference direction of a manipulation by a manipulator on a basis of information regarding an aspect of a part of a body of a user; and

a control function of controlling an output related to the manipulation in accordance with information regarding a motion of the manipulator with respect to the decided first reference direction.

### REFERENCE SIGNS LIST

100 information processing device
102 communication unit
104 recognition unit
106 decision unit
108 control unit
200 measurement device
300 projection device

1. An information processing device comprising:
a decision unit configured to decide a first reference direction of a manipulation by a manipulator on a basis of information regarding an aspect of a part of a body of a user; and
a control unit configured to control an output related to the manipulation in accordance with information regarding a motion of the manipulator with respect to the decided first reference direction.

2. The information processing device according to claim 1, wherein the aspect of the part of the body includes a shape of the part of the body.

3. The information processing device according to claim 2, wherein the decision unit decides the first reference direction on a basis of a shape of a region decided from information regarding the shape of the part of the body.

4. The information processing device according to claim 2, wherein the aspect of the part of the body includes a positional relation between a first part and a second part adjacent to the first part.

5. The information processing device according to claim 4, wherein the second part includes a part related to a movable range of the first part.

6. The information processing device according to claim 1,
wherein the part of the body includes a part that grips the manipulator, and
the aspect of the part of the body includes an aspect of gripping of the manipulator.

7. The information processing device according to claim 1, wherein the aspect of the part of the body includes movement of the part of the body.

8. The information processing device according to claim 1, wherein the manipulator includes a part of the body.

9. The information processing device according to claim 1,
wherein the manipulator includes an object different from the body, and
in the control of the output related to the manipulation, the first reference direction and a second reference direction of a manipulation by the object are switched.

10. The information processing device according to claim 1, wherein the first reference direction is fixed on a basis of information regarding an action of the user with respect to a target of a manipulation by the manipulator.

11. The information processing device according to claim 10, wherein the action of the user includes an action involving a motion of the user or an action not involving a motion of the user.

12. The information processing device according to claim 1, wherein the control unit further controls an output of notification with respect to the decided first reference direction.

13. The information processing device according to claim 12, wherein the control unit controls an aspect of the notification on a basis of information regarding the aspect of the part of the body used to decide the first reference direction.

14. The information processing device according to claim 12, wherein the notification includes display of a virtual object indicating the first reference direction.

15. The information processing device according to claim 14, wherein the virtual object is displayed at a position corresponding to a position of a manipulation by the manipulator.

16. The information processing device according to claim 1, wherein the decision unit decides the first reference direction further on a basis of information regarding an attitude of the user.

17. The information processing device according to claim 1, wherein the decision unit decides the first reference direction further on a basis of information regarding an aspect of a display screen related to a manipulation by the manipulator.

18. The information processing device according to claim 1, wherein the decision unit decides the first reference direction with regard to each of a plurality of users.

19. An information processing method comprising, by a processor:
deciding a first reference direction of a manipulation by a manipulator on a basis of information regarding an aspect of a part of a body of a user; and
controlling an output related to the manipulation in accordance with information regarding a motion of the manipulator with respect to the decided first reference direction.

20. A program causing a computer to realize:
a decision function of deciding a first reference direction of a manipulation by a manipulator on a basis of information regarding an aspect of a part of a body of a user; and
a control function of controlling an output related to the manipulation in accordance with information regarding a motion of the manipulator with respect to the decided first reference direction.
